(19) United States
(12) Patent Application Publication
(10) Pub. No.: US 2003/0152904 A1
(43) Pub. Date: Aug. 14, 2003

(54) Network based educational system

(76) Inventor: Thomas R. Doty JR., Mableton, GA (US)

Correspondence Address: HINKLE & O'BRADOVICH, LLC, 395 SCENIC HIGHWAY, LAWERENCEVILLE, GA, 30045, US

(21) Appl. No.: 10/307,255

(22) Filed: Nov. 29, 2002

Related U.S. Application Data
(60) Provisional application No. 60/334,107, filed on Nov. 30, 2001.
(60) Provisional application No. 60/343,411, filed on Dec. 18, 2001.
(60) Provisional application No. 60/357,150, filed on Feb. 16, 2002.
(60) Provisional application No. 60/410,046, filed on Sep. 12, 2002.

(51) Int. Cl. G09B 3/00

(52) U.S. Cl. 434/350

(57) ABSTRACT

A network based educational system is described. The system generally includes a student interface, a classroom interface and an administrative interface. Synchronous and asynchronous applications are used, typically with streaming video to deliver courseware to learners on the system.

Priority based on U.S. Provisional Patent Applications, Serial No. 60/334,107, filed Nov. 30, 2001, entitled “INTERNET BASED EDUCATIONAL SYSTEM”; Serial No. 60/343,411, filed Dec. 18, 2001, entitled “INTERNET BASED EDUCATIONAL SYSTEM”; Serial No. 60/357,150, filed Feb. 16, 2002, entitled “IMPROVED INTERNET BASED EDUCATIONAL SYSTEM”; and Serial No. 60/410,046, filed Sep. 12, 2002, entitled “FURTHER IMPROVED INTERNET BASED EDUCATIONAL SYSTEM”is claimed.

### BACKGROUND OF THE INVENTION

I. Field of the Invention

The present invention relates generally to the field of Network Bases Educational Systems and more particularly to an Internet based educational system providing streaming video synchronized with user interactive applications to enhance the total educational experience for those taking advantage of the present system.

II. Description of the Related Art.

The widespread use of the Internet as a mechanism for exchanging information provides dispersed individuals with the ability to retrieve information previously available to only those living in the general vicinity of the information source. For example, a man living in Buffalo, N.Y. can listen to the radio broadcast of a Los Angeles Dodgers game and a student living in Flagstaff, Ariz. can read the Washington Post from the convenience of her kitchen table.

Educational systems are one area of information exchange that has yet to fully take advantage of the Internet's capability to provide information to individuals living at remote locations. Educational systems have primarily suffered from an inability to recreate the interactive nature of classroom lessons. For example, most people who have taken an online course typically agree that it is difficult to remain involved in the course during the entire lesson. Recent studies indicate that online training sessions have proven to be so unengaging that only 70% of the learners are sufficiently motivated to complete the course.

Original computer based educational systems began as text based environments, with a few images scattered about the classroom environment in an effort to relive the monotony of the text-heavy environment offered by such systems. The next development added video segments interspersed throughout the computer based classes. Learners typically read a bit of text, perform an exercise and watch a short video to illustrate a principle. The systems apply the video and text in a linear and sequential format, where one is required to complete one segment of learning before preceding to the next learning segment. Such systems can be more engaging than pure text based systems, but remain limited. Typically, it is unknown whether or not the user is learning, and the system relies upon the same linear framework as the text based systems.

There still lacks a media rich, compelling Internet based educational system. However, media rich systems with interactive applications inherently necessitate greater bandwidth, more extensive platforms and increased application restraints. Therefore, these constraints limit the potential audience as applications become better adapted for new students due to bandwidth, platform and applications constraints for potential users worldwide.

### SUMMARY OF THE INVENTION

In general, the invention features a network based educational system. The system generally includes a student interface, a classroom interface and an administrative interface. Synchronous and asynchronous applications are used, typically with streaming video to deliver courseware to learners on the system.

In general, in one aspect, the invention features a network based educational system, including a student portal providing each student on the system with a personalized knowledge platform, a classroom interface providing an online classroom environment; and an administrative portal facilitating the deployment, maintenance and updating of course materials provided on the system.

In one implementation, the classroom interface is composed of synchronous and asynchronous learning applications.

In another implementation, the classroom interface is driven solely by streaming video to bring instructional materials to students participating in the system

In another implementation, the streaming video is composes of both asynchronous and synchronous learning applications.

In another implementation, the asynchronous learning applications include archived streaming video content.

In another implementation, the asynchronous learning applications include slides synchronized to video.

In another implementation, the asynchronous learning applications include message board including threaded messaging.

In another implementation, the asynchronous learning applications include contact including internal classroom messaging.

In another implementation, the synchronous learning applications include email.

In another implementation, the synchronous learning applications include testing composed of real-time questions and data collection.

In another implementation, the synchronous learning applications include chat including real-time interactive text chat.

In another implementation, the synchronous learning applications include polling including real-time polling.

In another implementation, the synchronous learning applications include live streaming video including live webcast within classroom interfaces.

In another implementation, the synchronous learning applications include a user information module composed of student name, email address and real-time scoring.

In another implementation, the synchronous learning applications include a quick access video menu including access to course video modules.

In another implementation, the synchronous learning applications include a system performance module composed of a user's system performance console.

In another implementation, the streaming video includes time specific commands that drive interactive elements of the system.

In another implementation, the time specific commands drive flash slides.

In another implementation, the time specific commands drive real-time questions and answers.

In yet another implementation, the time specific commands are data script commands issued at specific time.

In another still implementation, the data script commands are embedded in the streaming video to JavaScript functions within the html and communicate with various media elements making up the system.

In another implementation, the streaming video is provided with time stamps stored within a database of the system.

In another implementation, the system further includes means for applying the time stamps to allow students to return to a specific stopping point in the event of an unplanned stoppage in receipt of class material.

In another implementation, the means for applying includes a database of coursemarker tables recording a last question/slide seen by a student and a dynamically created video file sent to a student upon resumption of a discontinued class session.

In another implementation, the administrative portal includes a question provider option allowing providers to monitor and control response time to test questions making up the classroom experience for students.

In another implementation, test questions are associated with a predetermined response time and predetermined ramifications are established for students failing to answer the test questions within the predetermined response time.

In another implementation, the system is AICC and SCORM compliant.

In another implementation, the system further includes means for identifying a student's connection speed and forwarding a student appropriate video format based upon the identified connection speed.

In another implementation, the system further includes a system test functionality.

In another implementation, the system test functionality identifies operating system characteristics of a student chosen from the group consisting of an operating system, color depth, resolution and browser version, Internet Protocol address, host name, versions of software and bandwidth.

In another implementation, the system test is a Javascript function.

In another implementation, the network is the Internet.

In another implementation, the classroom interface provides for real-time testing of students.

In another implementation, the classroom interface is streaming video to bring instructional materials to students participating in the system.

In another implementation, the streaming video includes time specific commands that drive the real-time testing of students.

In another implementation, the time specific commands are data script commands issued at a specific time.

In another implementation, the data script commands are embedded in the streaming video to JavaScript functions within the HTML and communicate with various media elements making up the system.

In another aspect, the invention features a network based educational interface, including a student interface, a classroom interface and an administrative interface, wherein the student portal, the classroom interface and the administrative portal are each functionally linked to each other.

In one implementation, the student interface comprises a plurality of graphical elements functionally linked to a plurality of additional interfaces.

In another implementation, the classroom interface comprises a plurality of graphical elements functionally linked to a plurality of additional interfaces.

In another implementation, the classroom interface further comprises streaming video linked to one or more of the graphical elements.

In another implementation, the classroom interface further comprises asynchronous and synchronous applications linked to one or more of the graphical elements.

In another implementation, the system further includes a self-publishing tool adapted to encode streaming video, index the streaming video and send the encoded video for use in the classroom interface.

In another aspect, the invention features a method of providing a network based education, including providing content on the network for a plurality of learners, providing a platform from which the learners can receive the content, delivering the content on the platform and supporting the content and the platform on the network.

In one implementation, providing content comprises delivering streaming video.

In another implementation, the video can include test questions to which one or more of the learners can provide answers.

In another implementation, supporting the content comprises providing updated video content as needed.

In another implementation, supporting the content further comprises providing real time measurement of the learners ability to retain the content.

In another aspect, the invention features a method of online education, including providing streaming video on a network, sending questions and receiving answers through the streaming video, optionally resuming the streaming video if the video was interrupted, providing an auto-detect feature on the network to adjust the streaming video as needed and providing a systems test to optimize the streaming video delivery

One advantage of the invention is that the system provides has greater ability to obtain, deliver and manage their video powered courseware.

Another advantage is that the system delivers more enriching and engaging educational experiences.

Another advantage is that the system increases access to a wider potential client audience.

Another advantage is that all offline and online training can be centralized.

Another advantage is that the platform language can be instantly translated into another language.

Another advantage is that the content can be modularized for on demand access by users.

Another advantage is that content can be created and updated easily.

Another advantage is that the core streaming media allows for rapid deployment of the platform.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a system overview diagram of an embodiment of a network based educational system;

FIG. 2 illustrates a schematic of a platform of an embodiment of a network based educational system;

FIG. 3 illustrates a schematic of an embodiment of the system architecture of a network based educational system;

FIG. 4 illustrates a schematic of an embodiment of four components of a network based educational system;

FIG. 5 illustrates a chart of an embodiment of functional elements of a network based educational system;

FIGS. 6, 7, 8, 9 and 10 illustrate embodiments of interfaces used with a self-publishing tool;

FIG. 11 illustrates an embodiment of a main page for a student portal;

FIGS. 12 and 13 illustrate embodiments of interfaces used in conjunction with a student portal;

FIG. 14 illustrates an embodiment of an interface screen shown upon completion of a system test;

FIG. 15 illustrates an embodiment of an interface used as a classroom interface;

FIG. 16 illustrates an embodiment of a table demonstrating the interaction between the streaming video and the classroom applications linked thereto;

FIGS. 17, 18, 19 and 20 illustrate embodiments of interfaces for use in conjunction with an embodiment of an administrative portal of a network based educational system; and

FIG. 21 illustrates a schematic of an embodiment of a system in which a learning management system is integrated.

### DETAILED DESCRIPTION

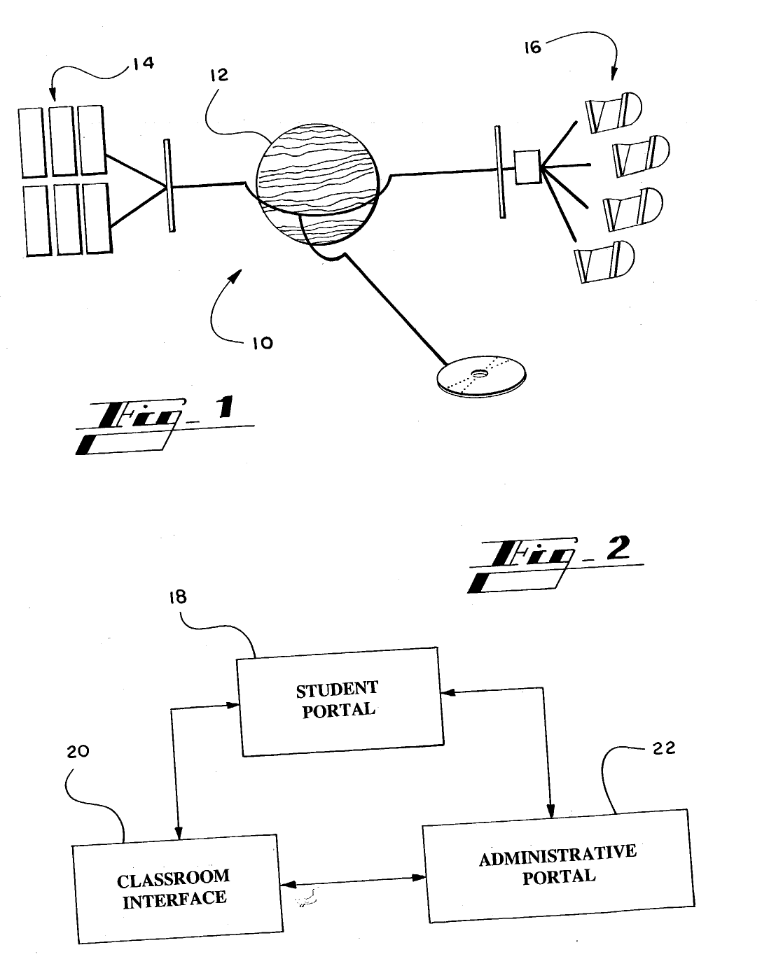

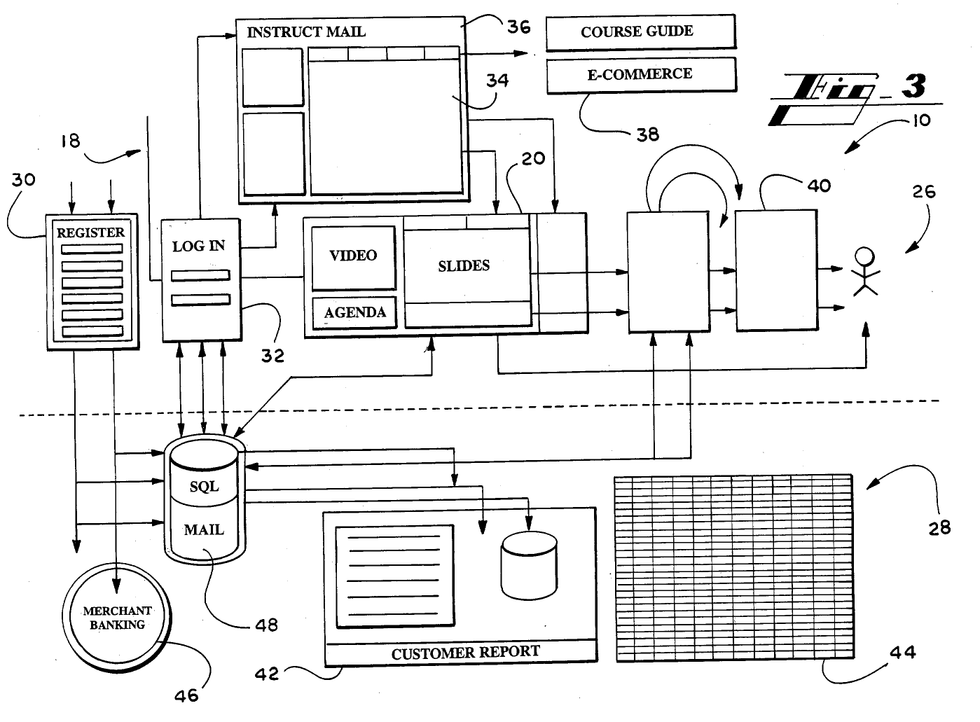

Referring to the drawings wherein like reference numerals designate corresponding parts throughout the several figures, reference is made first to FIG. 1 that illustrates an embodiment of a network based education system 10. Typically, the network on which the system 10 is used is the Internet, which is used as an example throughout. The system typically operates via the public Internet 12 by linking a server 14 maintained by system operators with a plurality of end users 16. Referring generally to FIG. 2, the education system 10 generally includes a student portal 18 providing each student with a personalized knowledge platform, a classroom interface 20 driven solely by streaming video to bring instructional materials to students participating in the educational system 10 and an administrative portal 22 facilitating the deployment, maintenance and updating of course materials.

In an embodiment, streaming video is typically used in the educational system 10. Through technology, infrastructure and partnerships, the educational system 10 allows educational providers to easily deliver, implement, update and measure the most enriching Internet based learning experiences to the widest possible audience. The education system 10 makes it easier for educational providers to obtain, deliver and manage their video-powered courseware, deliver more enriching experiences and access a wider potential client audience.

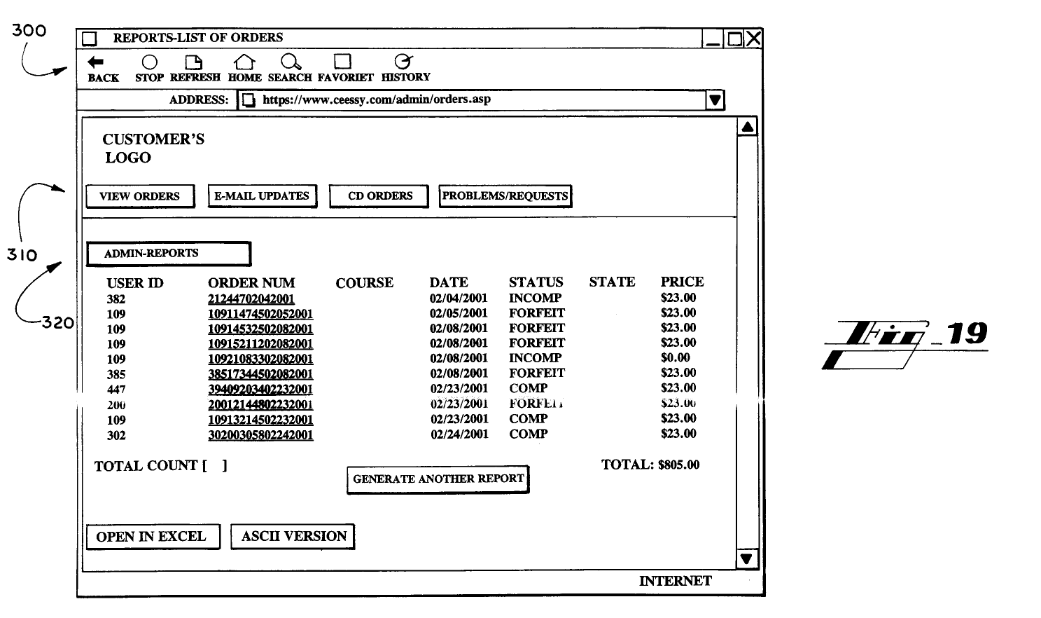

As is discussed in greater detail in the description below, streaming video drives the educational system 10 by linking the execution of classroom applications with time stamped course markers 24 (see FIG. 16) embedded within the streaming video. The time stamped course markers 24 instruct the system 10 to activate selected classroom applications at specific times during the streaming video presentation. In this way, all activities that are presented to the student at his desktop (i.e., the terminal, PC, workstation and the like by which the student accesses the system 10) are tied to the ongoing streaming video.

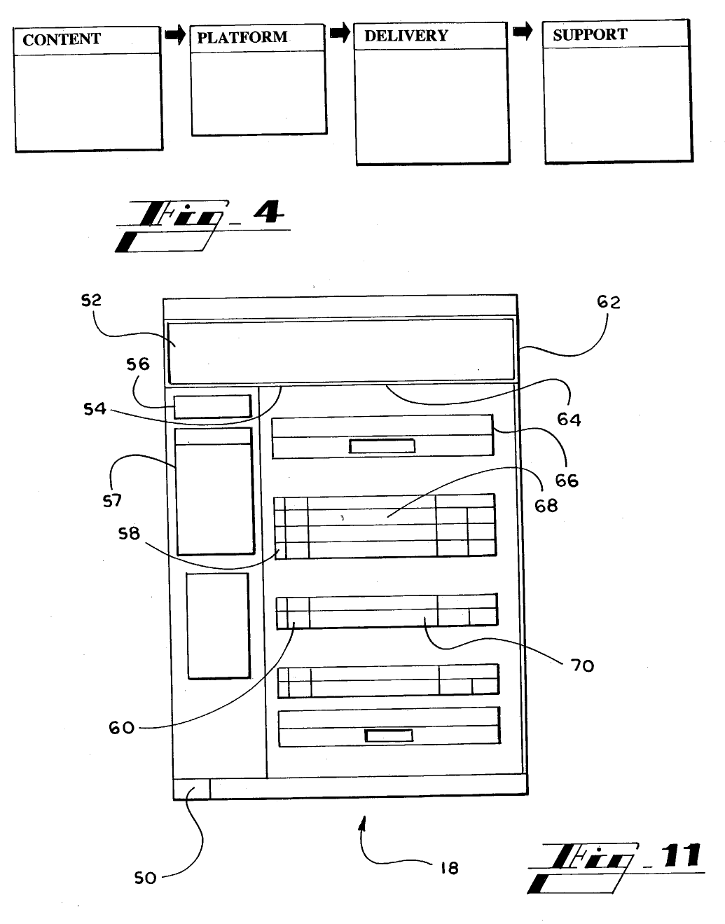

FIG. 3 illustrates a schematic of an embodiment of the system architecture of a network based educational system 10 that includes a front end 26 readily accessible by students, instructors and educational providers. The system 10 further includes a back end 28 where information is stored and processed for transmission to the front end users. The front end 26 includes various access points such as registration 30, user log-in 32, classroom interface 20, user profile 34, mail 36, e-commerce 38 and course certification 40. The back end 28 is configured to provide the necessary processing and backup to support is operation of the system 10 and includes customer reporting features 42, databases 44, merchant banking 46 and mail processing 48. As is discussed in further detail below, the system 10 includes a complete system operation and includes several functional components.

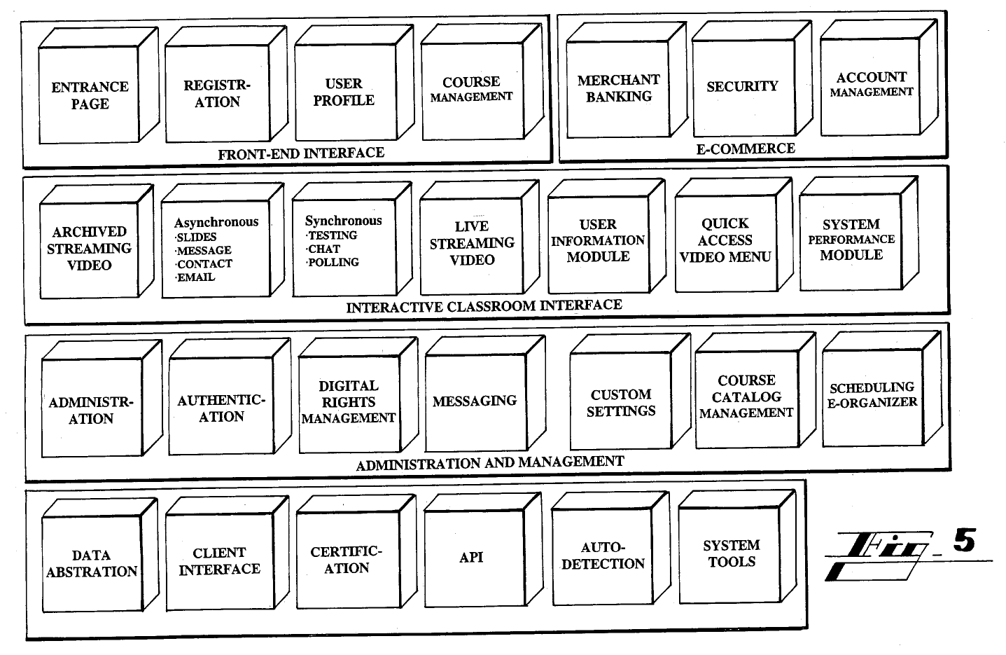

In one embodiment, the system 10 includes a number of distinct components that provide a useful and engaging Internet based educational system 10. For example, FIG. 4 illustrates a schematic of an embodiment of four components of a network based educational system 10. The system 10 combines I) content, II) platform, III) delivery and IV) support in providing educational providers, instructors and students with a highly viable Internet based educational system 10. These four components working in close conjunction can be essential to the operation of the system. For example, if the system included content, a platform and support, but no means of delivering the content to learners, then the system 10 would exclude an important functionality.

I. Content

Several references are made to e-Learning. E-Learning typically includes a combination of online training, knowledge management and performance support. Training typically includes the requirement of interruption to participate, a dictation of how the user learns and the transference of skill and knowledge. Knowledge management typically includes the guidance of performance, less interruption from work, learning being secondary to performance and the assistance of performance. In a typical implementation, content can be delivered in a efficient manner in which the content is delivered in small bits for on-demand learner access. A typical goal for courseware is better performance with higher retention in a shorter amount of time. The courseware can be video-driven, media-driven, course-driven and learner-driven. Several presentations such as by instructors, video and software can be offered. In an implementation, several different types of exercises can be offered.

In a typical embodiment, it is desirable to have custom content. In order to create custom content, video, real world examples, role plays and case studies can be implemented. A typical courseware customization process includes a process of assessment, design, development, implementation and evaluation.

In the assessment process, the user evaluates the strengths and weaknesses of the existing instructional content and creates a plan that best integrates the content with the platform of the system 10.

In the design process, the user designs courses that are interactive and engaging that can include instructional strategy options, course/module component options, media assets and layout options, new production time and cost-saving technologies, exercise and activity options, testing options, learner response tracking options, learner response feedback options, content security and digital rights management (DRM) and content localization.

In one embodiment of the design process, the ability to select a question from a limited list to be answered by an expert. That expert's answer (audio or video) typically resorts/adds to the available questions to include logical/typical follow-up questions. This implementation can mainly serve as a research or “additional information” tool. In one embodiment, questions can fall into several categories including but not limited to alternatives, background, context, examples, indicators, opportunities, results, warnings and the like.

In another implementation, nebulous questions/situations that do not have a traditional correct/incorrect answer, but are posed to provoke deeper thinking and an appreciation of the relative merits and pitfalls of any proposed solution.

In another implementation, manageably sized examples of real/fictional companies (based on rights) that were confronted with a decision. Their decisions and the ramifications of those choices could either be presented up front (more of a traditional “case study” that is used for reference/illustration rather than evaluation) or the student could be asked for the action they would take, with the feedback including the actual outcome.

In another implementation, an effective way to learn is to teach others. This template places the student in the role of an expert who has a series of virtual business people pose questions about a specific situation. It is a more direct and personal version of a Case Study.

In another implementation, to illustrate the principles/guidelines of interface and interaction design, present a fictional mock up or slightly edited version of a real web page, and have the student ID its strengths and weaknesses.

In cases in which the instruction can support the chat and/or discussion group capabilities of the platform, a potentially rich educational method is to ask students to consider a question and post their thoughts/reactions to a community forum for others to read. The seed questions can be linked to the course material and the real-world realities that a student faces, should be open ended without a definitive right or wrong answer in order to stimulate discussion and should be able to be answered in no more that two or three paragraphs. This class activity promotes creative and critical thinking skills.

In considering design strategies, content, application requirements, user's cognitive and affective requirements, relevant learning theories and desired levels of learning can be considered. Demonstration can gain the user's interest, illustrates a concept or procedure, application, result, feature or benefit, show relationships and effects and provide a model to visually reinforce content. Tutorial can tech new or advanced concepts and sequence, combine content with questions and interactivity to maintain interest and reinforce learning. Practice can allow a learner to interact, explore and experiment with content and skills and provide feedback. Drill can provide the opportunity ro increase speed and accuracy and demonstrate ability as well as progressing score or time accuracy through repetition. Problem solving can provide the opportunity to analyze and manipulate variables then generate potential solutions. Discovery and exploration can encourage learners to discover goal through self-direction and allow learners to manipulate elements, observe results and determine rules. Model building can provide the opportunity to examine components that comprise and object and enable creation of a whole object from components. Simulation and games can create a model of a real world situation and allow a learner to manipulate variable, observe results, draw conclusions, evaluate consequences of their decisions and receive a penalty or reward based on decisions. Case studies can provide a simulation in which results from one simulation affect a subsequent simulation and the theme usually builds from one episode to the next, allowing learners to gather information. Testing and evaluation measures performance and skill mastery. Results can be scored and tracked and can be used before or after learning. Other types of instructional strategies are contemplated including but not limited to calculation, classification, matching, screen completion and ongoing scenario.

In another embodiment, interactive segments can be used to allow the learner to participate in the application using one or more of the senses including sight, sound, touch and emotional reaction. Demonstration can include watching a video and observing an animation of procedure. Tutorial can include reading conceptual information, listening to a description of an object and viewing a picture of the object and viewing the procedural steps performed in a video or animation. Practice can include performing steps of a procedure, classifying items into specific categories, performing calculations and matching items or objects with appropriate definitions. Drill can include watching a video of a process then placing the procedural steps in sequential order with a specified time limit, listening to a set of instructions and performing tasks as directed. Problem solving can include watching a video then generating a lost of actions to solve the issue, reading a report, documenting important facts contained in the report and applying the facts to satisfy certain requirements and listening to a discussion, clarifying the important issues and generating potential solutions. Discovery and exploration can include selecting compounds to mix, viewing animated demonstrations of the results and mixing colors on a pallette. Model building can include assembling the components of a manufactured product and watching an animated demonstration of the assembly for verification. Simulation and games can include watching a scenario (video), selecting appropriate resources to bring the scenario to a successful conclusion, generating potential outcomes to a problem and watching an animated demonstration of the results of each. Case studies can include listening to the facts of a case, applying procedures and receiving feedback on the results and observing an experiment or expedition them documenting the progress. Testing and evaluation include watching a video then answering content related questions, performing calculations that apply to a concept and performing a procedure or answering specific questions about the procedural steps.

In another embodiment, components can be formulated with interactive activities. After determining which instructional strategies are most important for the application, the interactive activities can be conceptualized that encourage and maintain student involvement. These formulations can reflect the levels of learning that apply to the target audience and can be based on content, specified goals for learning the content/skills and characteristics of the target learner. Interactive activities can range from operational to cognitive within a set of course/module components that can be either passive or active. Passive components can include description that require a learner to read or view a passage of text, a procedure or other visually presented concept and view or listen to a video ro audio explanation list or description. Another passive component can be examples that can include a description of module goals, diagrams, photographs and other graphic images, a list of module objectives, text-based or narrated concepts or definitions and animated sequences and video clips. Active components can include description that involves the learner by requiring a physical action of some sort including responding to a questions, making a selection and manipulating an object. Active components can also include examples that include exploration interactivities, menus, questions, problem solving simulations, exercises and model building. Components can be delivered to the learner in various forms including but not limited to a single screen, a group of screens that pertain to the same concept and a base screen with optional links to other screen modules or applications. There are a multitude of different examples of component types. A few to illustrate the concept include but are not limited to goals (intro to lesson organization), objectives (formal, performance-based), purpose statement of content, definitions, navigational guides, relationship maps, introduction to screens or forms, application tool practice (simulated or with external software), simulation (problem solving), screen completion, model building (visual), visual classification, ongoing scenario with trailers, case study simulation, descriptive summary of lesson concepts, practice questions with response-specific feedback, scored questions: content recall, exploration, calculations, forms, branching: exploration activities, links to other lessons, definitions and summary.

In another embodiment, there are several media assets and layout options that are discussed in further detail below that can include but are not limited to video and activity interface, video/activity and real time testing and/or feedback interface, activity only interface, full field interface and video only interface.

In another embodiment of the design process, software simulations can be implemented. In one implementation, using off the shelf screen capture programs content creators can capture screen shots in real time. When combined with audio narration, this implementation makes an easy way to assemble and present software simulations to internal and external audiences. The resulting files is typically a video files at approximately five frames per second. This type of files makes for a compelling presentation because due to the slower frame rate, the video window size can be substantially larger than the thirty fps window for full-motion video with no increase in bandwidth. Audio quality typically remains as good as in traditional video.

Still considering the design process, templates can be used to check/verify the understanding of concepts, information, and instruction. All could have an optional audio component. All can require the ability to evaluate the screen state and provide varying levels of feedback sophistication. One example is the ability to place text/graphic objects to specific locations on the screen. With text, this would be useful for creating standard or complex matching situations. With graphics, learners could be asked to “virtually” assemble a particular device or connect the various components of a product. Another example is to fill in the blank by the ability to type text in a field. Another example is matching which is the ability to identify matching items from two columns of items (usually by entering column 2 item's ID in a blank beside column I's items). Matching could also be implemented via drawing lines between items or drag/drop functionality. Another example is multiple choice which is the ability to select an item (text or graphic) from a list that is correctly related to a question/statement. Items can be randomly displayed from a pool of questions and appropriately weighed. Feedback could vary from basic (“Incorrect. Try Again.”) to intermediate (“That is incorrect for this generic reason’) to advanced (“That is incorrect for this specific reason.”). The number of learner attempts before the correct answer is revealed can vary from I to the # of answers minus 1, each with a potential for a specialized leading phrase (“You seem to be confusing . . . ”, “You still seem to be misunderstanding . . . ”). In another implementation of multiple choice, multiple selection choice which is multiple choice with more than one item that needs to be selected to be correct (replace Multiple Choice's radio buttons with check boxes). In still another example, hotspot screen select can be used as a specialized form of multiple choice where a region of the screen is substituted for a formal list of text/graphic selection options. Alternatively, it can be used in conjunction with fill in the blank/text entry to build screen simulations of applications. In still another example, the slider can be used which is the ability to select a value for a variable via a slider bar with present Min, Max, and increment values. Correct answers are given a range of variability +/−. In still another example, sort/order can be used which is the ability to rearrange a series of items into a specific order or grouping. Text entry can be used which is the ability to type text in a text box for evaluation. comparison, or storage for future use/reference by learner or training administrator. Still another example is simple true or false. In another implementation, mouse over can be used to reveal information or trigger animation based on the position of the mouse. Branching can also be used in which learners are allowed to review or discover information in a non-linear manner by choosing from items in a list. Information already known can be reviewed last or not at all/Custom specialized non-templated interactions can also be used.

In any of the embodiments discussed in the design process, learner responses can be tracked in a variety of implementations. Examples include but are not limited to tracking or response feedback, no tracking but response feedback, tracking only right or wrong and tracking and cataloging actual response.

In an embodiment, the system 10 can provide connections with providers who can help in the design for courses, graphic design, web development, production, development of a course catalog, hosting and serving development and general technical support. As described above in greater detail, many sources of the streaming video is provided. In another embodiment, video can be produced with broadcast anchors and proctors available for the video production. Any necessary video editing, in-studio production or remote production can be provided with the system 10. Existing content can be integrated as needed. Further services generally include complete web portal development, digital encoding services and the like.

Moving from the design process to the implementation process, a complete Web hosting solution including all of the hardware, software, network equipment and support necessary to run the e-Learning platform can be used. In one implementation, credit card information is also processed using SSL (Secured Socket Layer) technology to secure transactions. Web server certification and client is ensured using SSL's Message Authentication Code (MAC). This feature encompasses the entire transaction engine and is designed for the highest level of security with SSL. Dynamic HTML pages are generated after processing server side asp files and interaction with the SQL database ensuring proper validations. Fully Interactive CDs can be implemented. This CD content allows users interactive access to the course currently available online. The information taken while using this CD is recorded on a user's database, accessed from customer's administrative portal. In another implementation, a non-interactive CD allows user to view the course video, slides and questions without an Internet connection. The questions are “faked” in the questions box and no information taken from this CD is gathered on a database. In another implementation, a looping CD plays the course in a loop. There are no questions and no Internet connection.

In the evaluation process, designs can be periodically reviewed to ensure compliance with requirements set forth in the above discussion.

The system 10 accommodates an educational provider's use of newly produced video, existing video, off the shelf video and repositioned off the shelf video. The system provides substantial focus upon the utilization and production of newly produced custom content. In one embodiment, newly produced custom content can be achieved by directing educational providers to utilize facilities, resources and expertise maintained by operators of the system 10 to produce their own video content that can drive new courseware. In an embodiment, Media Learning Objects (MLOs) can be used to update current courseware. The MLOs are typically small media powered content that can be accessed individually of in a series as a course or program. The MLOs allow the user to update content of the courseware that is outdated.

While the development and use of new video courseware is contemplated in one embodiment, existing footage or courseware already at the disposal of the educational providers can be used. For example, the system 10 can utilize video content from a variety of sources including but not limited to video-taped content in all major tape formats (e.g. SVHS, BetaSP, Hi8, DigiBeta), local in-studio production, Ku/C satellite feeds, FTP (file transfer protocol) and remotely encoded streams.

Typically, once exiting footage, or courseware, is identified by an educational provider, the system operator can encode the content into a Windows Media format for insertion into the platform of the system and dissemination over a network such as the Internet. It is understood that other formats for use with other operating systems is also contemplated. Through the system's 1—encoding process, pre-recorded video is formatted instantly for use as downloadable or streaming Internet media and at all bit rates (typically up to 8 Mbits). It is understood that other encoding techniques can be used in the system 10 in other embodiments.

In addition to existing footage and/or courseware, the system 10 is capable of using off-the-shelf video-powered course libraries maintained in the system operator's own course catalog. Specifically, the developers of the system 10 can use the best off-the-shelf courses from leading corporate training providers and media-enable such content into the platform of the system. These third party courses run in the classroom interface 20 just as any custom course runs in the interface 20. Educational providers can typically utilize an Internet based learning solution fully equipped with popular training titles as well as any custom courses they choose to create.

The off-the-shelf video-powered course libraries discussed above can be modified with custom intros and outros shot for specific educational providers. Educational providers can essentially reposition these courses with introductory and/or summary “bookend” messages of their own. For example, prior to the actual course, learners can see a familiar corporate face explaining the importance of the material. At the class's conclusion, the same person reappears to summarize hoe the information is best put to use by their enterprise.

In addition to those content sources discussed above, the system 10 offers a self-publishing tool for producing streaming video powered for use in conjunction with the system 10.

The self-publishing tool allows compilation of content and the preview of content whether supplied or self-published. IN a typical embodiment, the self-publishing tool allows media capability including the addition of an infinite number of encoded sessions based on standard profiles, editing in standard or advanced configuration, running sessions sequentially on demand or scheduled and previewing encoded media. The self-publishing tool also allows interactivity including the preview of flash slides and encoded video, adding slide times to video as video plays, add or modifying slide times independently of video and navigating to any point in video or any slide in flash file. The self-publishing tool also allows testing including adding pre-, during- and post-course questions, administering course questions, adding question times to the video as video plays, modifying question times independently of video and navigating to any point in the video. The self-publishing tool also allows publishing content including editing content profile, previewing finished content, having project save support and FTP support for uploading encoded media.

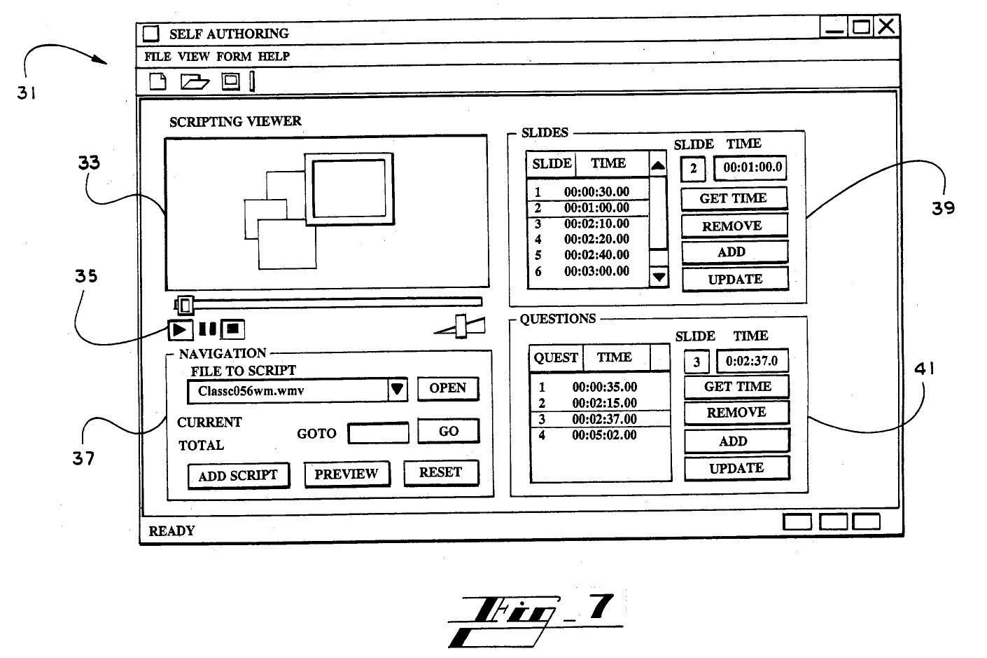

FIGS. 6, 7, 8, 9 and 10 illustrate embodiments of interfaces used with a self-publishing tool. In one embodiment, the self-publishing tool is written in Microsoft C++ (or similar programming language such as Borland C++ builder (Visual C++)). In addition, the self-publishing tool can be integrated with tools such as portions of Win Media Tools. In a typical implementation, the self-publishing tool is approximately 5 MB, uses Install Shield or Wise Solutions installer, maintains hardware requirements for a 450-500 Pentium III with 128 MB RAM and utilize the format software development kit from Microsoft. Other embodiments and implementations of a self-publishing tool are contemplated.

FIGS. 6 & 7 illustrate screen shots of embodiments of a self-publishing interfaces. The interface 31 typically includes a screen 33 in which the video can be viewed. The interface 31 also typically includes a video control section 35 including controls for play, pause, stop, forward, reverse and the like. The interface can also include a navigation section 37 in which videos can be navigated and chosen. The section 37 can include controls for scripting files, adding scripts, previewing, resetting or going to certain sections of the video. As discussed above, slides and questions can be inserted into the video. The interface can also typically include a slide section 39 and a questions section 41. Each of the sections can include controls for slide and question numbers and respective time stamps as well as controls for getting and removing slides and questions. Finally each of the sections 39, 41 can include an update control.

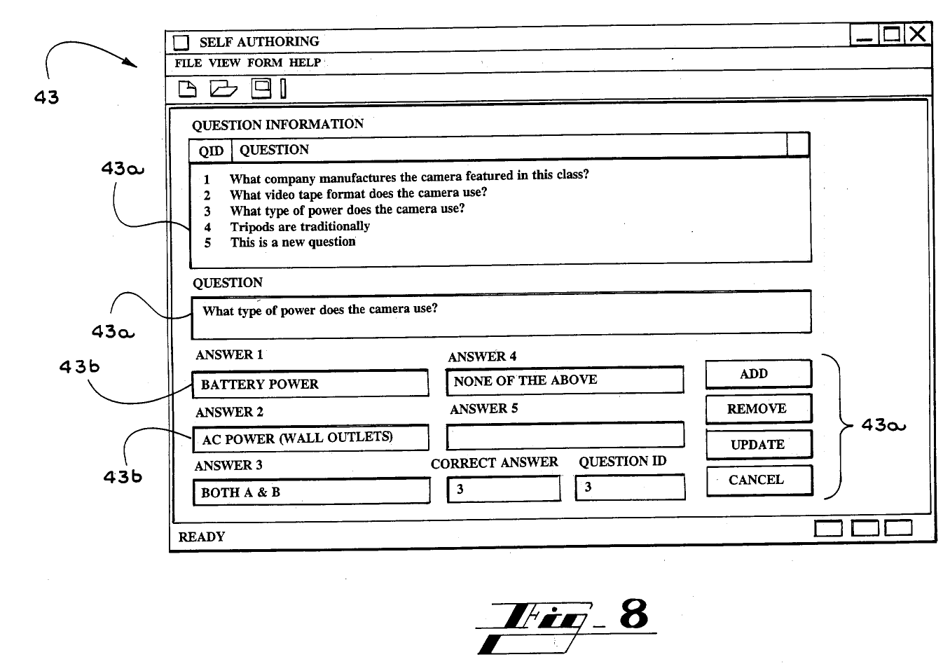

FIG. 8 illustrates a screen shot of an embodiment of a question information interface 43. The interface 43 can typically include fields 43a including question ID and corresponding questions as well as fields for answers 43b. The interface 43 can also include a control section 43c for adding, removing and updating question information. The section 43c can also include a control for cancelling the operation.

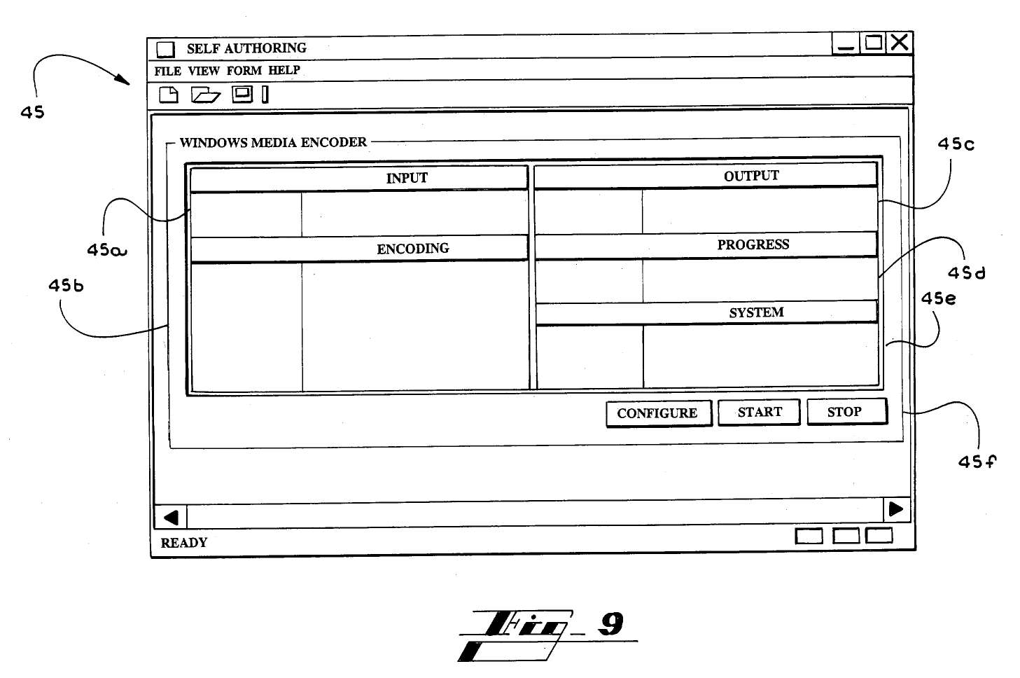

FIG. 9 illustrates a screen shot of an embodiment of a Windows Media Encoder Interface 45. The interface 45 can include an input section 45a displaying fields for video, audio and script. The interface 45 can also include an encoding section 45b including profile, video size, media bit rate, expected fps, current fps and total scripts. The interface 45 can further include an output section 45c including archive, broadcast port and connections. The interface 45 can further include a progress section 45d including elapsed time, estimated time and percent complete. Finally, the interface 45 can typically include a system section 45e including CPU load, disk space left and disk time left. The interface 45 can include a control section 45f to configure, start and stop the progress.

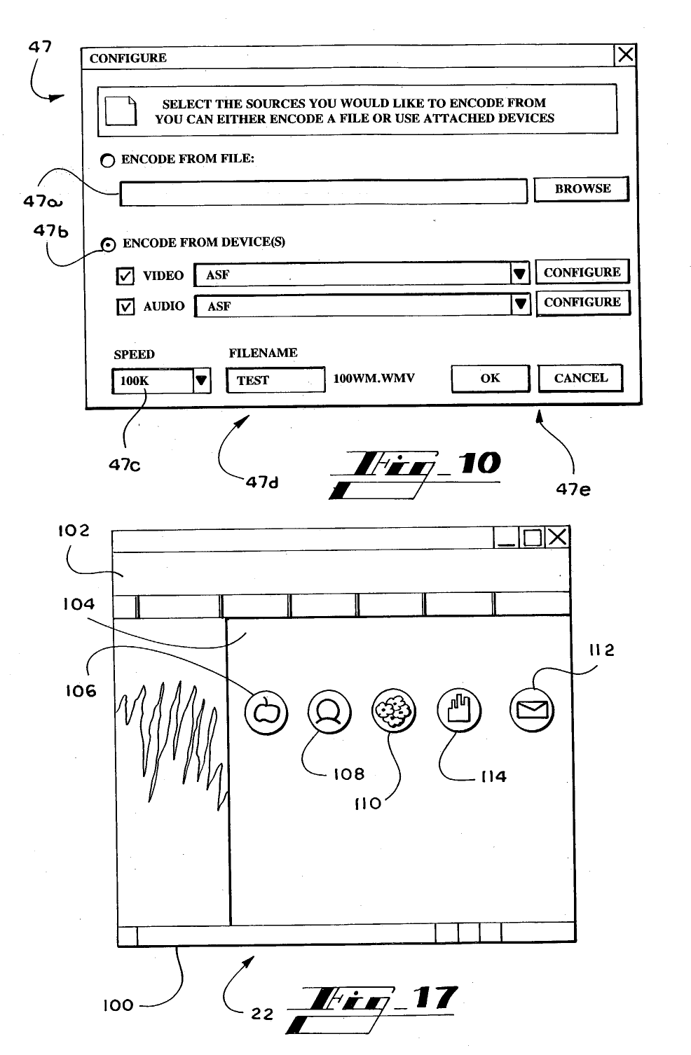

FIG. 10 illustrates a screen shot of an embodiment of a configuration interface 47. The interface typically includes a file encode section 47a and a device encode section 47b. The interface 47 also includes a speed field 47c for choosing the encoding speed as well as a filename field 47d. The interface 47 can also include a control section 47e.

The self-publishing tool typically includes a three step client-side stand alone application. This application is downloadable and is available for clients to create and edit their own forms and instructions.

The first step of the self-publishing tool application is to encode the educational provider's video into a Windows Media File that is time-stamped to include slides and/or test questions and answers. The video can be existing footage (video files accepted as input are typically AVI (Audio Video Interleaved), MPEG-1 (Moving Picture Experts Group), BMP (Bitmap file), MOV, WAV (Windows Audio Volume) or other suitable format) or live capture. Many streaming video speeds can be used but are typically 56, 100 and 300 Kbps. In addition, the encoding interface typically includes two windows, one to watch the video input and a second window to preview the video output.

The second step in the self-publishing tool application involves the indexing interface that allows clients to time-code slides and/or questions wile viewing the encoded video. Time stamps, or coursemarkers, are added realtime as the video plays or, if the exact timing of each slide event is known in advance all at once without having to play the video. This tool typically accepts FLA (flash) files as content, although other formats can be accepted. Each and every FLA event is typically indexed.

The third and final step in the self-publishing tool application involves the implementation of the FTP client. FTP is the standard Internet protocol and currently an easy way to transfer files between computers on the network. Like Hypertext Transfer Protocol, which transfers displayable Web pages and related files, and the Simple Mail Transfer Protocol, which transfers e-mail, FTP is an application protocol that uses the Internet's TCP/IP protocols. FTP is commonly used to transfer Web page files from their creator to the computer that acts as their server for everyone on the Internet. It's also commonly used to download programs and other files to computers from other servers. In an embodiment, the published content of the self-publishing tool is FTP published to the system operators. This interface allows the educational providers to compile and send new or edited slides and/or test questions and answers.

The system 10 self-publishing tool allows educational providers to publish their own video-powered courseware and video presentations. This features provides educational providers the ultimate in creativity and flexibility. If they have video content and FLA files available, they are able to encode the video into a system-ready format, synchronize the slides (and test questions where appropriate) and FTP them to the system operator for hosting and delivery.

II. Platform

In an embodiment of a platform, certain hierarchical criteria can be implemented. Some typical hierarchical definitions include a system that is a unique instruct portal, the system having its own set of properties such as a main page URL, the initial page once logged in can either be created and hosted on our servers or hosted remotely, system contacts for: support, billing and administration. A system can typically have different versions and modules and a system has a unique DS, ID, and set of branding, as well as independent versions of any/all modules. A module is a particular feature that is independent of the system a module can be: “my courses”, course guide, new user sign up, admin, schedule, message boards, framework (the actual look and feel “skin” of the system), file upload, related resources, help system and the like.

A user is a single person who enrolls with the system. A user can belong to one or more groups. A user can be a learner, an instructor, or an administrator. A user may sign up for courses or series that have been assigned to that user or a group to which they belong.

A group is a collection of one or more users or groups. A group is created/deleted by an instructor. A group can be either public or private. A public group is visible everywhere in the system for example sales, or marketing. A public group would appear in a new user sign up (a user can elect to be a part of this group). A private group is created by an administrator or instructor o a private group could be managers, or administrators o a user or group is placed into a private group. Typically, when a group is deleted no users in that group are deleted, they are just removed from that group.

A course is the smallest single unit of courseware that makes up a whole. A user can not enroll in a class that is currently incomplete. A course can have several properties and attributes in the platform. For example, there can be a maximum number of times that a user can enroll in a course.

A course can have a number of licenses associated with it, this means if a course has 1000 licenses, then that course may be enrolled in I 000 times, if a user enrolls in a course twice because they forfeited the first time, that is 2 uses of the license. A course is only visible to a user or a group once it is assigned to a user or group a course can be assigned to one or more groups or users for enrollment.

A series is a group of courses that can be enrolled in by a user or a group. A series is typically only visible to a user or a group once it is assigned to a user or group and can be assigned to one or more groups or users for enrollment.

A singleorder is when a user/group enrolls in a course. An order has certain properties that tie it to both a user and a course. Ordernum is a unique number for all orders for all users. Status is typically incomplete, complete or failed). Mode is typically normal, browse or review. A user can take notes and it is tied to that order. Miniscore is typically the minimum score required to pass. Maxscore is typically a mastery score.

A bundleorder is when a user/group enrolls in a series. Typically, the only properties for a bundle order are status, and certificate, and series name.

The platform of the system 10 makes the content available for transmission to students in a useful format. Referring again to FIG. 2, the platform of the system 10 typically relies upon three interfaces to deliver an Internet based educational system 10 to consumers and educational providers. The three interfaces are typically, a student portal 18, the classroom interface 20 and the administrative portal 22. Specifically, the student portal 18 is each student's access point to the system 10 through which they can make purchases, view personal account status, take classes, chat with instructors and fellow students, and even share files for group projects. The classroom interface 20 brings the instructors to the student's desk top. The administrative portal 22 allows instructors and administrators to easily deploy, maintain and update courseware. As discussed above, MLOs can be used to update those portions of the courseware that is outdated. The real-time reporting features integrated with the administrative portal 22 measure results down to the finest detail. The self-publishing tool discussed above allows one to update and fine-tune content so as to deliver the most rewarding and effective training to students.

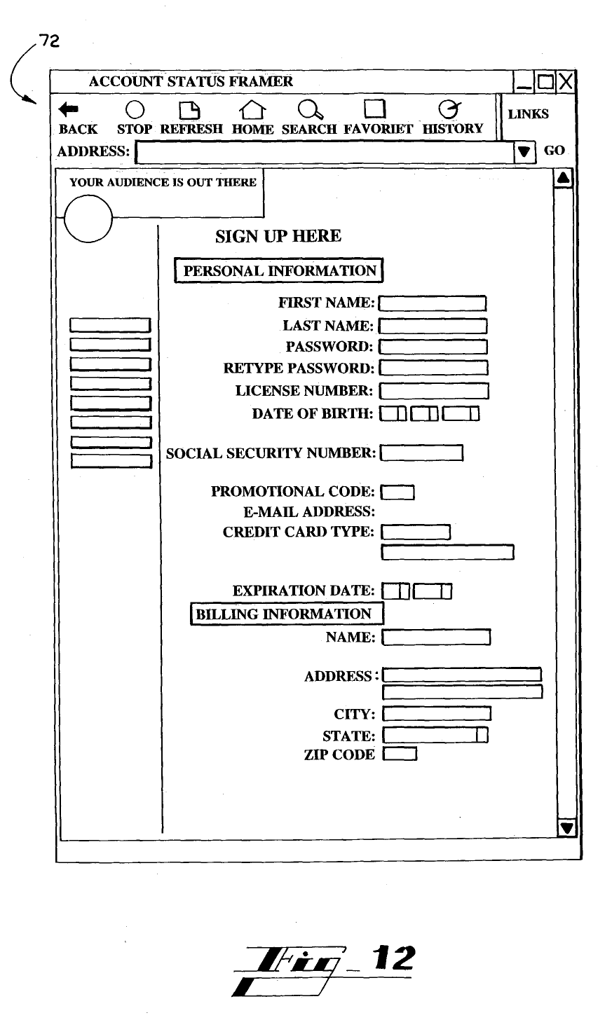

FIG. 11 illustrates a screen shot of embodiment of a main page for a student portal 18. The portal 18 is effectively a mini website provided for access by students, or end users of the system 10. The introductory page 50 of the student portal 18 includes a branding area 52, resource center 54, message alert 56, general alerts 57, course information 58, real time polling 60, message center 62, course guide 64, link to a personalized homepage 66, course links 68, and notes feature 70. In a typical embodiment, the student portal 18 includes a main page in which the user can view systems polls, surveys, emails, alerts and the like. The user can also view courses and course status including complete, incomplete, forfeited, printable and all courses. The user can also view a course guide or a scheduler function that typically operates as a personalized calender. The student portal 18 can also typically include a course management section in which the user can launch online and view alerts, information, related resource links, file uploads, notes, message boards, email and the like.

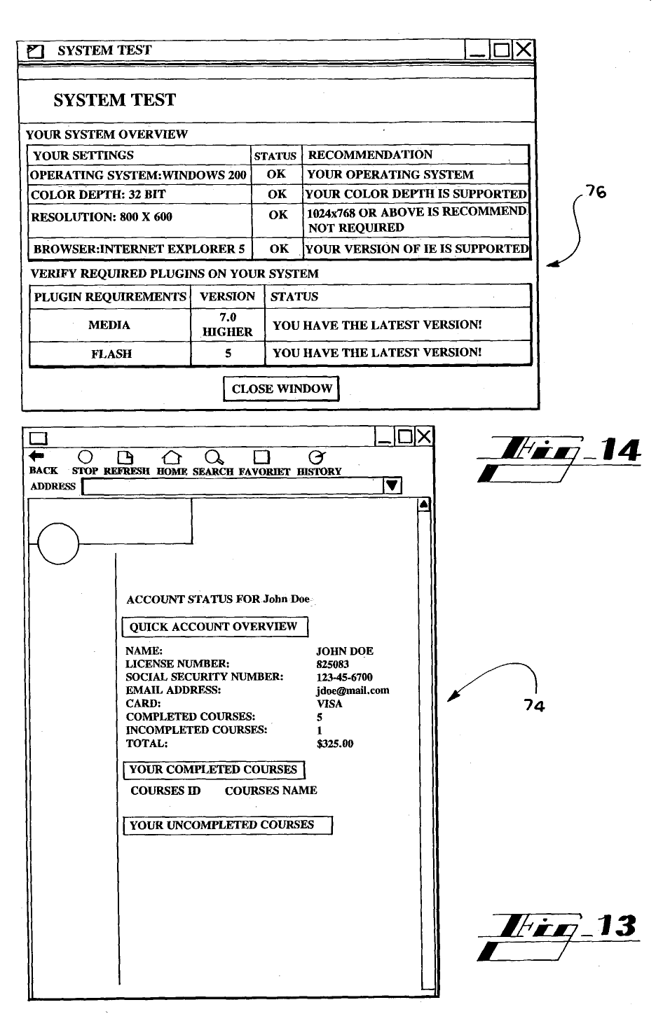

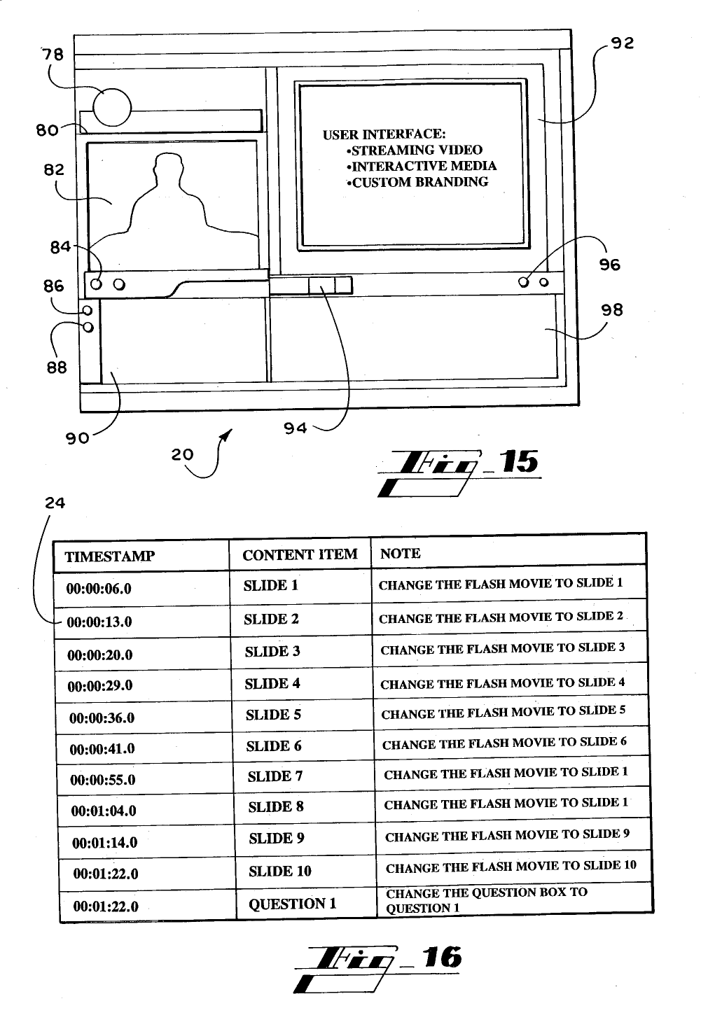

The student portal 18 further includes a sign up page 72 (See FIG. 12), forgotten password page, user profile page 74 (see FIG. 13) and contact page. The sign up page 72 and user profile page 74 are typical of those type of pages currently implemented in a wide variety of websites.

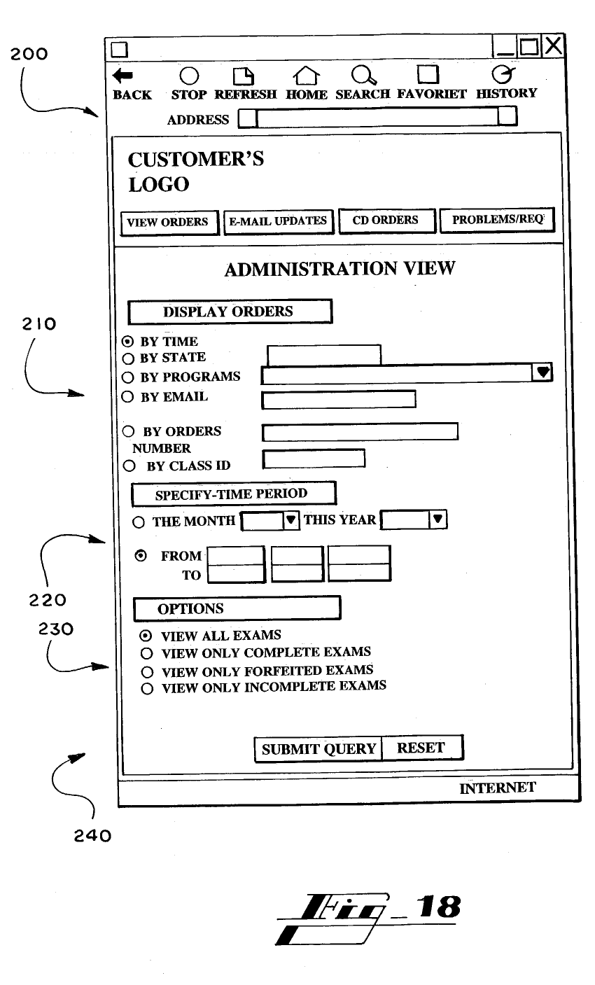

If the user completes the sign up page, he is provided access to the classroom interface (see FIG. 15.) Prior to being provided with access to the classroom interface 20, the user receives the introductory page 50, or login success page, welcoming the user to the system 10 and presenting the user with a list of available classes, as well as those classes the user has already taken and the status of those classes. A system test is then typically applied by the system 10 to determiner if the user's system has the minimum required specifications.

FIG. 12 illustrates a screen shot of an embodiment of a sign up page 72. The sign up page 72 typically includes a personal information section including fields for name, password, license number, date of birth, social security number, promotional code, email address, credit card type, credit card number, credit card expiration date and other pertinent demographic information. The page 72 can also include a billing information section having fields for name, address, city, state, zip code and other pertinent demographic information.

FIG. 13 illustrates a screen shot of an embodiment of a user profile page 74. The page 74 can include account status information such as a quick account overview having information including name, license number, social security number, email address, credit card number of courses completes, number of incomplete courses, charge and other pertinent information. The page 74 can also includes a complete course section listing the courses that have been complete. The page 74 can also include an incomplete course section listing the incomplete courses. The page 74 can also list a section of forfeited classes.

FIG. 14 illustrates a screen shot of an embodiment of a system test interface 76. The interface 76 can typically include fields listing the system overview including operating system, color depth, resolution, browser and other pertinent information. The interface 76 can also include a filed for verified plugins on the users system such as Windows Media version, Flash version and other pertinent version information. In an implementation, the system test typically uses a variety of JavaScript functions to verify a user's operating system, color depth, resolution and browser version. JavaScript is an interpreted programming or script language from Netscape. It is similar in capability tp Microsoft's Visual Basic, Sun's Tcl, the UNIX-derived Perl, and IBM's REX. In general, script languages are easier and faster to code in than the more structured and compiled language such as C and C++. Script languages generally take longer to process than compiled language, but are very useful for shorter programs. JavaScript is commonly used on Website development to do such things as automatically change a formatted date on a Web page, cause a linked-to page to appear in a popup window and cause text or a graphic image to change during a mouse rollover. JavaScript code can be imbedded in HyperText Mark-Up Language (HTML) pages and interpreted by the Web Browser (or client). JavaScript can also be run at the server as in Microsoft's Active Server Pages before the page is sent to the requester. It is understood that other script languages, compiled languages or other suitable language format can be used in other embodiments.

The system test also typically detects the installation of Flash and Windows Media. Depending on the version of Windows Media, the system test also checks for specific audio and video codecs (compression/decompression). The user is then typically prompted for download if any of the desired requirements are not met. Upon logging into the student portal 18, students are given the option to conduct the system test. Like the auto detect feature discussed below, this test takes the burden of technology out of the hands of the learner. The system test automatically tests the learner's operating system and plug-ins to ensure each and every learner is capable of receiving the most engaging and trouble-free e-Learning experience that is possible.

In one embodiment, the technology disclosed in commonly owned U.S. patent application Ser. No. 09/635,563, entitled “SYSTEM AND METHOD FOR DISTRIBUTION OF ENCODED VIDEO STREAM TO MULTIPLE CLIENT PLAYERS SIMULTANEOUSLY”, filed Aug. 1, 2000, which is incorporated herein by reference, is utilized in the implementation of the disclosed system 10. However, those skilled in the art appreciate that other system test mechanisms can be used.

The user typically uses the classroom interface 20 to watch and engage the content in accordance with the system 10. Since, different educational providers typically provide different content, the look and feel of the classroom interface 20 tends to vary to a large degree as the desires of the educational provider change. However, the system's functional components are accessed by the students via the classroom interface 20, which is now discussed.

FIG. 15 illustrates an embodiment of an interface used as a classroom interface 20. The classroom interface 20 is typically adapted to provide streaming video, asynchronous applications, synchronous applications, live streaming video, a user information module (typically providing student name, email address and real time recording to name a few), quick access video menu and a system performance module. The classroom interface 20 can include a branding area 78, an auto detect button 80 (discussed in further detail un the description below), streaming video window 82, video control buttons 84, user information 86, system performance information 88, quick access video menu links 90, synchronized graphics window 92, slide controller 94, notes link 96 and real-time testing window 98. In another typical embodiment, the classroom interface 20 can include a chapter index in which courses can be intuitively segmented giving learners the freedom to move quickly from section to section to return to sections for review. In another implementation, the classroom interface 20 can include closed captioning for audio constrained or foreign language environments that displays spoken words as text. The classroom interface can also typically include a system performance feature that allows the learners to check and regulate their system to ensure that they are properly set up to receive the full-powered impact of the system 10. The classroom interface 200 can further include a notes features that allows a learner to make notes as the material is being presented and they can review their notes at any time from the student portal 18. The classroom interface can further include a user stats section in which learner responses are recorded to the database and displayed back in real time. The classroom interface 20 can also typically include a scheduler that allows users to organize their e-Learning events and activities. Users can typically instantly export their e-Learning schedules to their other software modules such as Microsoft Outlook.

As discussed above, the platform uses streaming video to drive the entire network based educational system 10, including but not limited to, slides, test questions and the like to create a (on demand) video-centric learner environment, blending synchronous and asynchronous learning. Specifically, the video can communicate and drive other interactive elements (for example, flash slides and real time questions and answers) by sending data script commands at specific times that are embedded in the video to Javascript functions within the HTML, which in turn communication with the other media elements with the system 10 . It is understood that other methods and languages can be used to communication and drive the interactive elements.

The system provides a platform that uses streaming video to drive the entire classroom experience. Using the video centric system 10, learners can interact with video and slides, respond to questions, all at their discretion without having to first compete with a content segment. In general, the application of a video driven educational system 10 can provide a learner with a linear framework that replicates a classroom environment that is engaging and can measure how well the students learn form the video stream.

FIG. 16 illustrates an embodiment of a table demonstrating the interaction between the streaming video and the classroom applications linked thereto. In a typical implementation, all classroom applications are triggered by the video via script commands embedded into the video file at various coursemarker 24 times throughout the video. The script commands in turn communicate with JavaScript functions embedded in the classroom interface 20, or other interfaces used in conjunction with the system 10. The classroom applications controlled by the video file include, but are not limited to, the animated flash slides and real time questions. When a question is triggered by the video and then answered, the answer along with the timestamp of the video is logged into the database 44 of the system 10. The database 44 then recalls the time in the video when the last question was answered, so that a user returning to a course that is not completed can automatically restart at the time of their last completed question. However, it is contemplated that this method of tying questions and answers to the video may be adapted in other ways. Script commands designated at various coursemarkers 24 within the video instruct JavaScript functions within the classroom interface 20 to change the flash movie being presented to either slides or questions. The video is able to instruct the classroom interface 20 to function in this way since the JavaScript function in the classroom interface 20 has already been loaded and is waiting for a command from the video.

The system makes a video-driven system a viable option by combining technology, infrastructure and partnerships allowing educational providers to cost-effectively take advantage of a video-powered network (the Internet) system. Video is a medium to which the public typically responds positively. It has been determined that up to 83% of learning occurs visually. Video is therefore preferred to convey various types of information, from the most basic information to more advanced or complex information. Video also affords the ability to emphasize specific points and nuances. It also has been determined that video delivers higher retention rates. The system 10 uses video to drive synchronized slides, graphics and real-time features, such as, but not limited to, testing polling and chat. The result is a unique and enriching “virtual classroom” environment. The system's video-centric experience immerses students in the learning environment thereby delivering an engaging experience with a higher retention of material over the prior art.

Operators of the system 10 typically provide instructors and subject matter experts a venue to deliver their content similar to how they would deliver the content in a class, but with the added impact of web multimedia. Instructors typically do not alter their content to conform to the restraints of less web-based templates. In addition, system operators' state of the art content production and acquisition facilities manned by expert production staff help to ensure a highly polished and engaging courseware. High levels of production and virtual sets help bring instructors to the student's desktop.

As discussed above, the platform can provide a blend of synchronous and asynchronous learning. The Internet is designed for addressing large audiences at each individual's convenience. The system 10, by providing on-demand application that takes full-advantage of the Internet, allows educational providers to deliver training to a extremely large audience and virtually any network location, at the learner's convenience.

The present system 10 closely replicates the traditional classroom. It represents a blend of synchronous and asynchronous learning. Typically, synchronous programs are time dependent. They are typically schedules and delivery is “live”. Asynchronous delivery refers to programs that are independent of time (typically “pre-recorded”). Anyone can access the program at any time and as many times as desired. There is typically no “live” component, with no scheduling where communication between people typically does not occur in real time.

The system 10 offers both synchronous and asynchronous features. Synchronous features can include, but is not limited to, real-time testing and data collection that helps to ensure that students are actively engaged in the class, chat (real-time interactive text chat), polling (real-time), a user information module (including student name, email address, real time scoring and the like), a quick access menu (giving access to course video modules), a system performance module (having the user's system performance console) and the like. Features like e-Messaging, message boards and chat can promote active communication between learners and teachers. Resources such as file sharing and related links can allow students to share up-to-the-minute information. These synchronous features allow the user to build a sense of community across an enterprise. Asynchronous features can include, but is not limited to, archived courses (archived streaming video content), slides (typically synchronized to video), a message board (typically threaded messaging), alerts, polling, contact (internal classroom messaging), email, surveys and pre- and post-tests.

The system 10 typically offers a complete infrastructure and expertise to allow an educational provider to create, deploy and centrally maintain a video-powered university. The system 10 offers comprehensive content facilities including a state of the art in-house video production facility making it easy to produce new courses from scratch or to reproduce existing training; a core streaming media infrastructure offering turnkey encoding, hosting, serving and streaming services, typically reducing the need to purchase hardware and software or to hire highly specialized and expensive streaming video personnel; application development expertise based upon a proven history of developing and launching substantial web-based applications through the use of platforms that are highly stable, rapidly deployable and open standards for maximum compatibility; and centralized maintenance and management based upon the system's plug-and-play integration with Learning Management Systems, self-publishing tools for easy updates, online or offline administration of certificates, a scalable platform for adding courses or students and accessible support.

The platform of the system 10 can also provide educational providers with the ability to test and measure in real-time the student's ability to learn from the streaming media. The system 10 provides a real-time test questions to the learner during the video presentation of the course. The student's responses are recorded real-time and their total correct and incorrect answers are continually updated and displayed. The system's ability to test and measure how well the students are learning and preforming form the streaming video can result in the retrieval of valuable information for the administrators. Based on this information, they can utilize the test results to immediately fine tune the courseware content or test questions and answers for greater success and higher retention of knowledge.

In one embodiment, the system 10 is typically also Aviation Industry CBT Committee (AICC) and Shareable Content Object Reference Model (SCORM) compliant. SCORM enables the industry to package content from different vendors into a single course. Courses or content form multiple sources can be combined into a single package and then be managed in a learning management system using certain specifications. AICC typically uses high standards that can include interoperability that software vendors can use across multiple industries. Withe these types of standards, a vendor can sell its products to a broader market at a lower unit cost. AICC recommendations are fairly general to most types of computer-based training and for this reason is widely used outside f the aviation training industry. It is understood that other types of recommendations and standards are contemplated.

FIG. 21 illustrates a schematic of an embodiment of a system in which a learning management system is integrated. The system 10 is typically capable of operating independently or integrating with existing Learning Management Systems (LMS), The system 10 can be integrated with any LMS that is preferably SCORM or AICC compliant (other systems that are not compliant are also contemplated). In a typical implementation, a LMS has either documentation or a developer kit that can be provided to the system operator. This kit can contain all the information needed to plug-in. The kit can also tell the system operator the file structures, database structures and the like that may be required to plug-in. The system 10 is typically an open standards platform that integrates seamlessly with most major LMSs. Results are typically reported real-time and data abstraction and certification continues to be performed by an educational provider's LMS. In a typical embodiment, the system's application programming interface (API) communicates via eXtensible MarkUp Language (XML) thereby facilitating integration with LMSs. Furthermore, compliancy with the above-mentioned standards such as SCORM allows retention of core competencies allowing video to stream more effectively, thereby enhancing the functionality and overall learning experience offered by the system 10.

In one embodiment, as delivery is prepared though the platform, courses are created as Sharable Content Objects (SCOs) and enhanced with the addition of streaming media, security features, and additional functionality. In some instances, it is necessary for users to launch these SCOs from a 3d party Learning Management System. Other users may require existing courseware to be integrated into the platform. In either case, the platform is a Sharable Content Object Reference Model (SCORM) compliant platform able to easily launch any SCO.

In another implementation, Enhanced Media Technology (EMT) architecture enables the design and delivery of SCORM compliant courses with the addition of expanded media functionality beyond what SCORM standards typically allow. By using EMT architecture, courses can be delivered by the platform that employs functionality not included in SCORM's current standard capabilities. These courses, played in any other LMS, default to SCORM compliancy and operate as a SCO. Conversely, in another implementation, a SCO integrated into instruct from another provider will play with no diminished functionality.

A course delivered through the platform can offer all of the original functionality the Instructional Designer intended. Delivered through any other SCORM compliant environment, the course automatically defaults to basic SCORM standard specification and may play with slightly diminished functionality, with no integration or modification necessary. If the courseware is being run on the platform, this enhanced SCORM functionality may be designed into the course itself such as direct user access to email, file upload and chat. These enhanced functions are disabled if the courseware is delivered through another LMS.

In a typical implementation, the SCORM standard defines the process to integrate courseware with other e-Learning platforms. Whether integrating into the platform or any other LMS environment, XML files are launched in the platform and tested to ensure intended functionality. The instruct platform is completely SCORM compliant, making integration and interoperability a painless process.

Typically, SCORM standards dictate that courses are self-contained, meaning that all assets needed for a course to play are available without accessing external content. For example, if a SCORM compliant course attempts to access an asset outside of the server from which is it managed, the course stops functioning. EMT architecture allows the courseware to access assets from alternate servers such as in the case of streamed media. The course automatically checks to see if it is running on the platform and grants access to the streaming media server. If the course is accessed by an LMS or another e-Learning platform, the course performs an HTTP download of the video from the primary server. The course operates on both the platform and LMS environments. However, the course requires progressive download of the video. EMT courseware is smart in that it checks for external dependencies such as streaming servers and revert to SCORM functionality when the external assets are not present.

In another embodiment, the system 10 can be adapted to conform to foreign languages. The system 10 can utilize powerful software allowing the educational providers to maintain, administer and update all language content of their products. Typically, manual updating of the pages is not necessary. The system operators can create dictionaries to house foreign languages content. Using the content, the software can update the web pages (“displayed messages”) in accordance with the corresponding language. The software can be upgraded from old versions to latest versions. This software typically performs a large part of the project. Moreover, to help support people (and probably quality assurance people), the system operators are able to duplicate everything in English on the administrative portal pages, Corporations with offices and employees widely dispersed around the world are able to reach, teach and administer their people enterprise-wide with the system 10. Enterprises can put video-powered e-Learning to work for all their people, realizing maximum return on their investment.

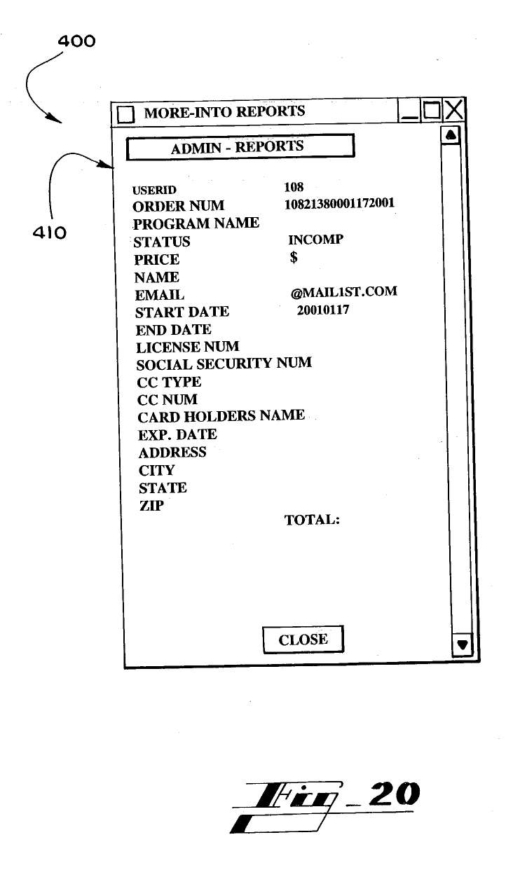

FIGS. 17, 18, 19 and 20 illustrate embodiments of interfaces for use in conjunction with an embodiment of an administrative portal 22 of a network based educational system 10. Generally, the main page 100 (FIG. 17) of the administrative portal 22 includes a branding area 102, personalized homepage link 104, course management link 106, user management link 108, system management link 110, message enter link 112 and report center link 114.

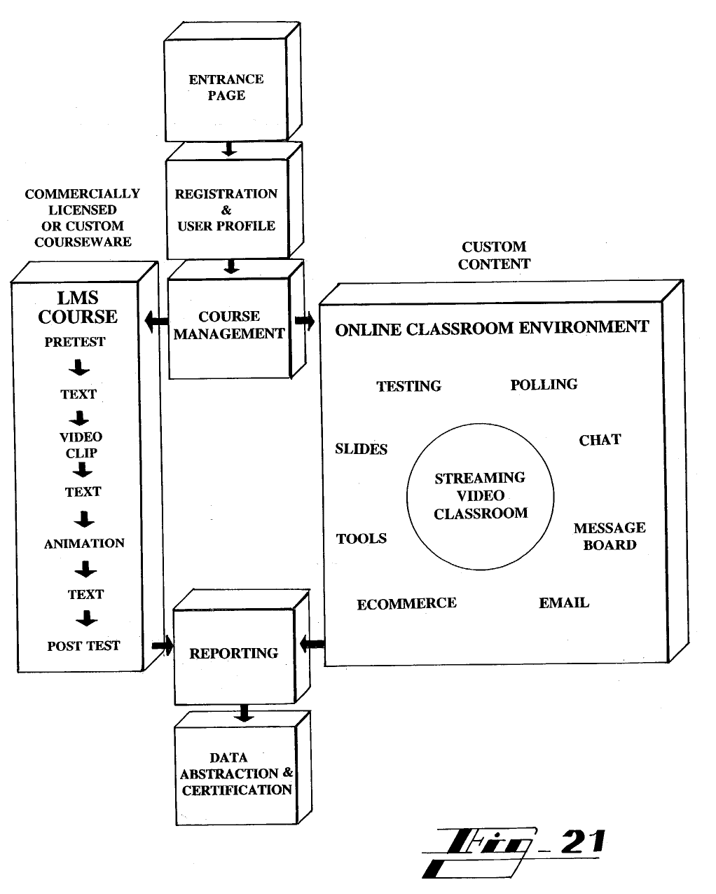

FIG. 18 illustrates a screen shot of another embodiment of a page 200 used in conjunction with an administrative portal 22. The page 200 can include a display order section 210 that can include controls for options to display the orders by time, state, program, email address, order number, class ID and the like. The page 200 can also include a section 220 for specifying the time period by month and year and ranges of the same. The page can also include an options section 230 for viewing all exams, corporate exams, forfeited exams, incomplete exams and the like. The page 200 can also include controls 240.

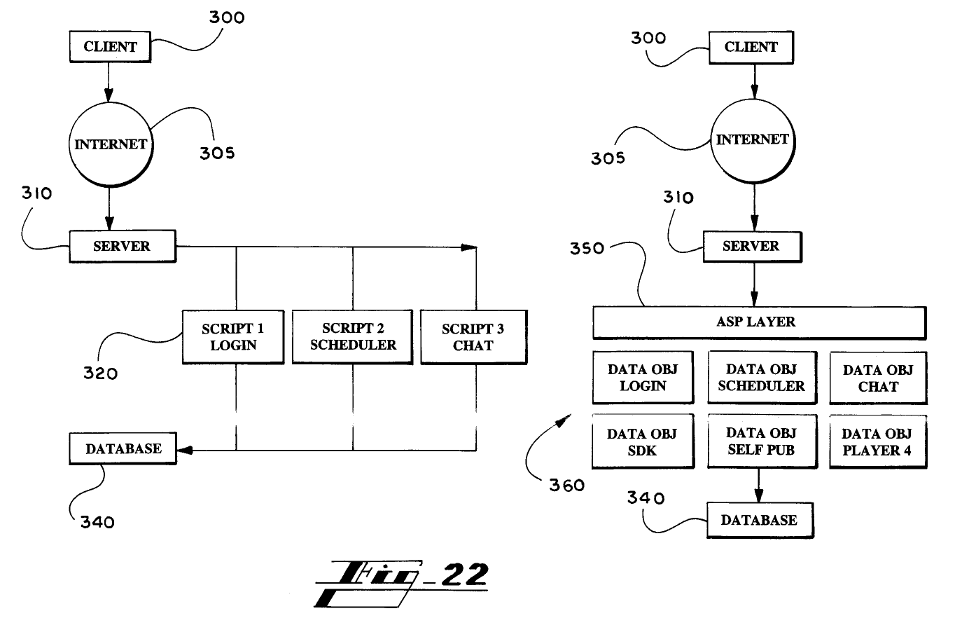

FIG. 19 illustrates a screen shot of another embodiment of a page 300 used in conjunction with an administrative portal 22. The page 300 includes controls 310 for viewing orders, emailing updates, CD orders, problems/requests, excel or ASCII versions, generating other reports and the like. The page 300 can also include an admin reports section 320 that can identify a user ID, name, order number, course name, date, status, state, price and the like.

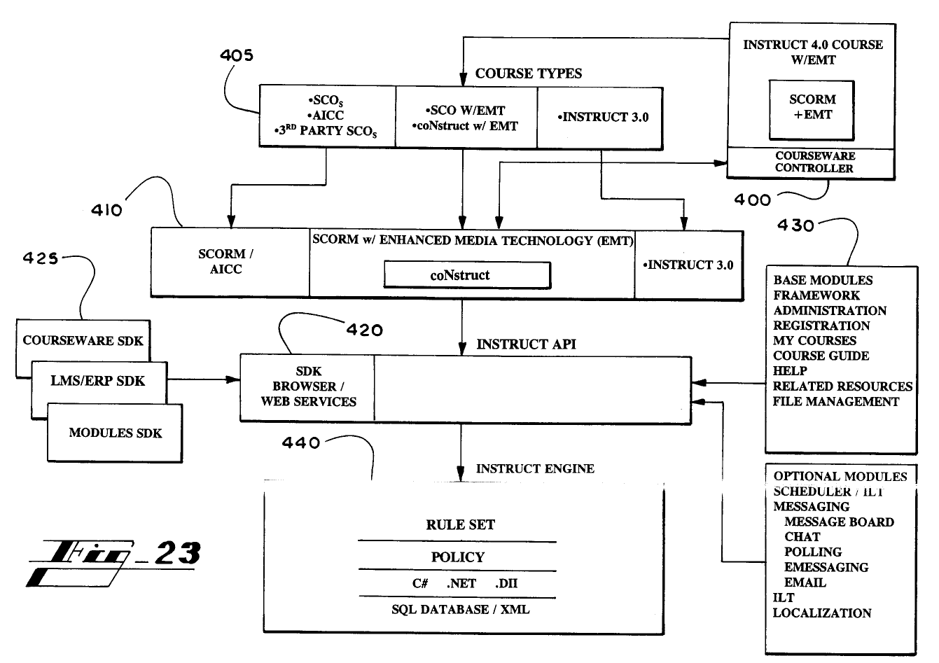

FIG. 20 illustrates a screen shot of another embodiment of a page 400 used in conjunction with an administrative portal 22. The page 400 can include an admin reports section 410 that can include fields for User ID, order number, program name, status, price, name, email, start and end date, license number, social security number, credit card type credit card number credit card expiration date, address, city state, zip code and the like.

It is understood that FIGS. 18-20 illustrate only examples of the types of pages that can be used in conjunction with an administrative portal 22. It is understood that several other types of suitable and appropriate pages are contemplated.

The administrative portal 22 typically features multiple levels of administration that allows the user to protect system information from the top down and to assign control where the user desires. When the administrator logs in, he typically has access to the functionality based upon a permission level. Typical uses of the administrative portal 22 can include enrollment of individuals and groups. Other uses include course management such as creating and editing course profiles editing availability, creating and editing questions and answers, polls, surveys and alerts, adding and editing related resource links, upload and message boards. The administrative portal 22 can also be used to manage users such as creating editing and deleting user profiles and group management such as creating editing and deleting group profiles. The administrative portal 22 can also be used for communications such as creating deleting and editing polls, surveys emails, alerts and the like. The administrative portal 22 can also be used for system updates such as viewing and requesting system and feature modules. The administrative portal 22 can also be used for support, administrative and billing contact. The administrative portal can also be used for reports such as user and group, course and series (including question and answer survey and poll), system (such as survey, poll and activity), contract and term (such as course and user licenses) and site traffic (such as web trends and traffic analysis). Access summary reports can be generated on a weekly basis and can include general statistics such as hits, page views, visitor sessions, most requested pages, visitors and demographics and activity statistics. Access information that can be tracked include number of total hits, total MB delivered, total minuted streamed and total number of unique viewers. Employee information can be tracked and can include number of total hits and number of successful hits. Employee information can include name, email address, department, username, password and retype password. Custom reports can also be created.

In another implementation, the administrative portal 22 can include an instructor led training manager that allows administrators to centralized all of their user's online and offline training into the platform. Enterprises can deliver and manage these “blended” learning options from one application. Administrators can typically create required and elective offline training events. Administrators can specify characteristics such as maximum occupancy for each physical classroom venue when creating the event. In another implementation, for required events they can actively enroll users and groups. For elective events, learners can choose to attend and are out on a wait list if the demand exceeds the number of available seats. Enrollment and wait list numbers are dynamically reported and lists can be printed to record attendance at the actual event. Administrators can then update student records to show if they attended, completed or did not pass the class.

In general, the administrative portal 22 can provide a mechanism for administrative functions including the generation of reports, hierarchical permissions, file sharing and account management, authentication, digital rights management (DRM), email messaging with administrator options, polling allowing the administrator or instructor to add/edit/modify polls, alert area containing new information relating to items such as course updates, messages from teachers, new messages, system updates and system maintenance, custom setting for specifying custom administration and user settings, related sources wherein instructors can post URLs and reference materials, course catalogue management, scheduling e-Organizing, filing sharing and the like. It is understood that many other mechanisms can be provided by and for the administrative portal 22 and that those listed above are for example purposes.

In one embodiment, authentication is typically provided by the administrative portal 22 utilizing Secured Socket Layer (SSL) technology to enable secure transfer of user information and integrated NY authentication (username and password). The technology also encrypts, authenticates and ensures data integrity. In a typical embodiment, a 40/128-bit key is used and helps to ensure a high level of security. In addition, the authentication technology protects critical credit card information.

As mentioned above, DRM is applied via the administrative portal 22, DRM vests the digital rights of the purchased or selected course/program to be accessible to the user after appropriate validations and checks or payments. This vesting may be for one time use, weekly, monthly, annually or other by other appropriate time period. DRM also prevents the user from successfully logging into the system and then emailing the streaming link to an outside audience. Digital rights are vested in favor of the user.

The emailing system discussed above typically includes three components. The emailing system includes a new mail component through which original mail is received, a message viewing component providing an area in which to view mail and move it around, and a compose mail component designed for sending mail only intragroup.

The file sharing component of the administrative portal 22 provides a place in which individuals can upload and download files. The file sharing component can either be set up to provide live sharing wherein users can upload and download a file when it is live to the group, or instructor approved sharing wherein an instructor must typically approve a file before the rest of the class sees it.

A further feature of the system 10 relates to an administrative portal 22 feature allowing administrators to optionally input a test question response time. For each class, they can preset test question response times to any desired appropriate duration. Should the student fail to answer the question in the allotted time, administrators can also prescribed the subsequent ramifications (i.e., the course is automatically forfeited). Each course can feature real-time test questions spaced throughout regular intervals with time-outs on the test questions. This feature measures and ensures that learners are actively engaged at the desk top. Typically, if they leave or become distracted from the class and fail to respond in the preset time, they risk forfeiting the class.

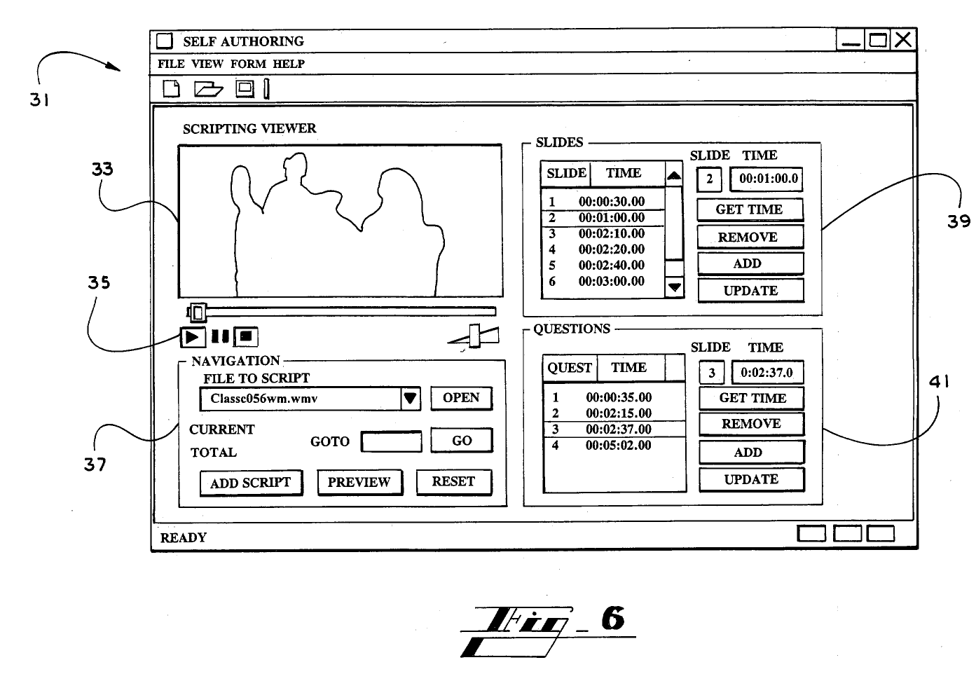

In addition to the student portal 18, the classroom interface 22 and administrative portal 22, the platform is further provided with a back end-architecture (see FIGS. 4-5). The back end 28 architecture typically provides the system 10 with features including but not limited to data abstraction consisting of data mining, data retrieval and/or data reporting, client database interface in the form of ASCII, delimited text file, formatted spreadsheets and the like, certification, application program interface, auto detection, system tools and the like.

Certification provided by the back end 28 architecture can include e-certificates awarded to course participants on the successful completion of the course as per the standards set by the educational provider. The grades can be posted to the database 44 and retrieved dynamically with the aid of active server page (ASP) files and HTML. An ASP is typically an HTML that includes one or more scripts (small embedded programs) that are processed on a server (i.e., Microsoft Web server) before the page is sent to the user. An ASP is similar to a server-side include or a common gateway interface application in that all involved programs that run on the server, usually tailoring a page for the user. Typically, the script in the Web page at the server uses input received as the result of the user's request for the page to access data from a database and then builds or customizes the page on the fly before sending it to the requester. ASP is a feature of the Microsoft Internet Information Server (for example), but since the server side script is simply building a regular HTML page, it can be delivered to almost any browser. One can create an ASP file by including a script written in any suitable format such as VBScript or Jscript in an HTML file or using statements such as ActiveX Data Objects program statements in the HTML file.

Certifications can also be sent to the student's appropriate supervisor via email upon completion of the course. More specifically, the platform provides for additional functionality by offering certification at various levels of operation. With regard to the student portal 18, registration and enrollment certification are required for e-Certification, pay-per-view and e-commerce applications. In each of these applications, the SSL technology is used to enable a secure transfer of user information. The student portal 18 also encrypts, authenticates and ensures data integrity. The student portal also protects the user's identity after registration.

As discussed briefly above, the system 10 provides for auto-detection of a student's system characteristics. The system 10 further identifies a learner's current connection speed to the network by sending a small amount of data packets to the computer, and then measuring the time it takes for those packets to return to the system operator. Once this time is ascertained, the system operator relays to the learner the appropriate video that correlates with the connection speed that is determined. These packets also detect the learner's browser, operating system, hardware, FLASH player, media player and the like. This auto detect feature take the burden of technology out of the hands of learners by detecting each user's operating system, connection strength and browser, and then automatically serving the optimum stream for that specific connection.

In an embodiment, the auto detect feature is provided with technology in accordance with the technology disclosed in commonly owned U.S. patent application Ser. No. 09/635,563, entitled “SYSTEM AND METHOD FOR DISTRIBUTION OF ENCODED VIDEO STREAMS TO MULTIPLE CLIENT PLAYERS SIMULTANEOUSLY”, filed Aug. 1, 2000, which is incorporated herein by reference. However, it is understood that other mechanisms can be used.

Once again, the auto detect feature helps to ensure that each and every student receives the most engaging experience that is possible. By generating greater platform and content delivery success and reinforcing the system's ability to provide content optimized for use by the students learning within the system 10, the system 10 optimizes learning. Auto-detection further includes the ability to perform a test. The system test uses a variety of JavaScript functions to identify a user's operating system, color depth, resolution and browser version. It also detects the installation of Flash and Windows Media. Depending on the version of Windows Media Player that is installed, the system test also checks for specific audio and video codecs. The user is then typically prompted for download if any of the desired requirements are not met. Upon logging into the student portal 18, students are given the option to conduct a system test. Like the auto detect feature, this test takes the burden of technology out of the hands of the learner. This tests automatically tests the learners operating system and plug-ins to ensure that each and every learner is capable of receiving the most engaging and trouble-free e-Learning experience possible.

The system tools discussed above relate to the platform's ability to resume a course at any point a student ceases participation and/or provide grouped course combined for certification. With regard to a resume course feature, the system 10 also typically allows a student to resume a course when they are forced to move from an ongoing class presentation. During the video presentation, the system 10 creates time stamps and stores then in a coursemarker table maintained on the system database 44. Should a student lose connectivity by either disconnecting intentionally (i.e, to receive an incoming phone call on a shared line) or unintentionally (i.e., a power interruption) then the video-powered classroom interface 20 automatically resumes at the last recorded time stamp when the learner chooses to take the class agin.

Resumption is typically achieved by monitoring the coursemarker table to look up the last question/slide a view saw for a particular program and dynamically creating a video file that is sent to the user upon resumption. This feature removed one of the inherent problems of online learning. Learners (especially those in less than stable connection environments) have the opportunity to be able to get back to the same point in the class without having to restart from the beginning or having the class voided entirely.

With regard to e-commerce application, the system 10 uses merchant banking to enable a credit card transaction to occur. Security of e-commerce transactions are ensured by employing Internet commerce security agents, for example, Verisign, to ensure that credit card information is processed using SSL technology to secure transactions. In one embodiment, the Web server certification and client is ensured using SSL's Message Authentication Code (MAC). This feature encompasses the entire transaction engine and is designed for the highest level of security with SSL. Dynamic HTML pages are generated after processing server side ASP files and interaction with the structured query language (SQL) database ensuring proper validations. In one embodiment, to help ensure a high level of security, user passwords are stored in an encrypted format with Message Digest 5 (MD5) encryption. At no time the password is sent over the network in its text format. The system 10 further provides for account management to log user's detailed credit card transactions.

III. Delivery

In a typical embodiment, via a network, like the public Internet, three delivery solutions are contemplated. In a first delivery mechanism, a full web-based version (typically suited best for users with 56 Kbps and above connections) runs on a fiber optic network that bypasses typical Internet congestion. The connection is typically virtual private network (VPN). With over 500 points of presence (PoPs) worldwide, this fault tolerant redundant network gives the most extensive reach of any service provider presently available, with the ability to support over three million concurrent streams and 80 concurrent live events. The auto-detect process checks the user's browser and connection speeds and then delivers media course content in its optimized and most engaging stream to each individual user. The system test ensures that the workstation us properly configured ti receive the full impact of the system 10. As discussed above, it checks operating system, color depth, resolution, browser, Internet Protocol address, host name, versions of software such as Windows Media, bandwidth and the like. If it detects a non-supported version of with plug-in, it provides a link for download of the latest version taking the burden off the user.

For environments where bandwidth is scarce or at a premium, a CD-ROM/Web hybrid version delivers the same high quality and engaging e-Learning experience at as little as 28 Kbps. Video content is housed on the CD itself, while the interactive, communication and reporting features remain fully functional on-line. The Cd can typically contain up to four hours of 300 Kbps content delivery, including all the HTML, images and slides for a class.

Deploying a video server behind a corporate firewall is a third distribution option. The video server resides on the corporate network without compromising security measures. The system operator then populates the server with video assets during off-peak hours to reduce the amount of bandwidth consumed by the download of video assets. Both CD and video server typically require only a low bandwidth connection to the Internet to register and record questions, answers and user login.

As described above, security on the system 10 is provided with SSL technology. In addition, encryption technology can be used to secure all data transfers associated with the interaction with the system 10. In a typical embodiment, data security is provided with a three-layer access barrier. Strict surveillance and audit procedures are conducted periodically to ensure the integrity of delivery including a manual review of all privileged access and/or changes to user assets.

In another embodiment, the platform in the system 10 is fully scalable for growth and throughput. Capacity typically can be increased to ensure the best possible viewer experience. Several storage options are also available on the system. A typical video file can store a duration of 30-40 minutes, although other durations are contemplated.

It is understood that many other delivery options are contemplated.

IV. Support

Several support options are contemplated in typical embodiments. Support for the system 10 can typically be accessed through any of the portals 18, 20, 22 as needed or at more technical levels from the front end 26 or back end 28 of the system 10. Support can be accessed by telephone, email, online connection and the like. In another implementation, support can also typically be provided on site. Any type of scheduled or unscheduled down time can be reported over the network. In a typical embodiment, any type of standard upgrades can be performed seamlessly with minimal interruption over the network.

Typically one of the biggest challenges of e-Learning is generating employee awareness and interest in the program. To assist users with the ongoing process of developing e-Learning within their organization, programs can be implemented to launch the platform and maintain e-Learning momentum. Programs can be used to assist users with marketing tools such as video email scripts, email templates and training that inform and update employees about the learning opportunities offered via the platform.

The implementation process can take many forms. In one implementation, the process generally includes requirements gathering, design, construction phase, testing, product deployment and marketing support. During a requirements meeting, certain needed features and functionalities can be defined and characterized. A statement of work is created with the client's input and requirements as the project begins. With the client's input and the use of existing logos and graphics, graphics designers and animators create the “look and feel’ for the new e-Learning platform. Slide templates, virtual sets and portal design is completed during this process. Development for the database, reports and integration issues are also completed by web development and programming teams. Specific design and construction requirements depend upon course level options. As the design phase completes, instructional design, video production and web development begin to create courseware. A script is produced and video is shot in the studio and on-location. A complete video asset is complete after editing and digital encoding. Synchronized slides and activities are integrated to accompany the video. Additionally, pre-produced courses can be available from a content library to augment the user's e-Learning platform.

Throughout the entire process, user approval and sign-off on treatments and assets is necessary to ensure a smooth implementation process. A QA process ensures that revisions are complete and the project is delivered to each of the user's specification. Upon sign-off of the platform and courseware, the platform is populated and ready for company-wide launch. Assistance can be provided with marketing support to ensure a successful launch and acceptance of the virtual university.

One of the biggest challenges of e-Learning is generating employee awareness and interest in the program. To assist users with the ongoing process of championing e-Learning within their organization, a program launch process can be used to launch the platform and maintain e-Learning momentum. Users can be assisted with marketing tools such as video email scripts, email templates and training that inform and update employees about the learning opportunities offered via the instruct platform.

During the implementation process, programs can be offered for consultation and design service for creating the plan of action necessary to launch e-Learning within the enterprise. The process helps the user choose the methods that best work for learner-employees and creates these messages, and deliverables.

In one implementation, a Launch Toolbox to assist in this launch process. It can contain tactics and marketing projects to promote e-Learning within your organization and motivate learners to return to the platform. Several templates for rich text emails, newsletter articles, inform video scripts are available to create launch materials.

In another implementation, training sessions can be available for technical and administrative staff that is supporting to the e-Learning platform. The administrative portal 22 can contain a section for frequently asked questions that can be periodically reviewed, reporting features and common technical and connectivity issues. Technical support escalation and call routing procedures are reviewed with the technical support staff during this training session.

In another implementation, the system 10 can provide connections with providers who can help in the design for courses, graphic design, web development, production, development of a course catalog, hosting and serving development and general technical support. As described above in greater detail, many sources of the streaming video is provided. In another embodiment, video can be produced with broadcast anchors and proctors available for the video production. Any necessary video editing, in-studio production or remote production can be provided with the system 10. Existing content can be integrated as needed. Further services generally include complete web portal development, digital encoding services and the like.

FIG. 22 illustrates an embodiment of basic application server provider foundations. IN one embodiment, a client 300 is connected to a network 305 such as the Internet that is connected to a server 310. The server 310 is, in turn, connected to a series of scripts 320 which can include a login, scheduler and chat script to name a few as described above. The scripts 320 are in turn connected to a database 340. In another embodiment, the client 300 is connected to a network 305 which is in turn connected to a server 310. The server 310 is connected to a number of objects 360 which can include but are not limited to login, scheduler, chat, SDK, self-publisher and player. The objects 360 are then connected to a database 340.

FIG. 23 illustrates an embodiment of basic platform architecture. The basic platform course 400, which is a mix of SCORM and EMT as described above, is connected to several course types 405. Both the platform course 400 and course types 405 are connected to a platform adapter 410. The adapter 410, which is SCORM with enhanced media technology as described above, is connected to the basic API 420. Several courseware modules 425 and other modules 430 are connected to the API 420. The API 420 is in turn connected to a platform engine 440 having basic rules and policies, having a SQL database.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on aprogrammable system including at least one programmable processor coupled to receive data and instructions from, and transmit data and instructions, to a data storage system, at least one input device, and at least one output device. Each computer program may be implemented in a high level procedural or object-oriented programming language, or in assembly or machine language, which can be compiled or interpreted. Suitable processors include, by way of example, both general and special purpose microprocessors. generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A network based educational system, comprising:
a student portal providing each student on the system with a personalized knowledge platform;
a classroom interface providing an online classroom environment; and
an administrative portal facilitating the deployment, maintenance and updating of course materials provided on the system.

2. The network based educational system as claimed in claim 1 wherein the classroom interface is composed of synchronous and asynchronous learning applications.

3. The network based educational system as claimed in claim 2 wherein the classroom interface is driven solely by streaming video to bring instructional materials to students participating in the system.

4. The network based educational system as claimed in claim 3, wherein the streaming video is composes of both asynchronous and synchronous learning applications.

5. The network based educational system as claimed in claim 2, wherein the asynchronous learning applications include archived streaming video content.

6. The network based educational system as claimed in claim 2, wherein the asynchronous learning applications include slides synchronized to video.

7. The network based educational system as claimed in claim 2, wherein the asynchronous learning applications include message board including threaded messaging.

8. The network based educational system as claimed in claim 2, wherein the asynchronous learning applications include contact including internal classroom messaging.

9. The network based educational system as claimed in claim 2, wherein the synchronous learning applications include email.

10. The network based education system as claimed in claim 2, wherein the synchronous learning applications include testing composed of real-time questions and data collection.

11. The network based educational system as claimed in claim 2, wherein the synchronous learning applications include chat including real-time interactive text chat.

12. The network based educational system as claimed in claim 2, wherein the synchronous learning applications include polling including real-time polling.

13. The network based educational system as claimed in claim 2, wherein the synchronous learning applications include live streaming video including live webcast within classroom interfaces.

14. The network based educational system as claimed in claim 2, wherein the synchronous learning applications include a user information module composed of student name, email address and real-time scoring.

15. The network based educational system as claimed in claim 2, wherein the synchronous learning applications include a quick access video menu including access to course video modules.

16. The network based educational system as claimed in claim 2, wherein the synchronous learning applications include a system performance module composed of a user's system performance console.

17. The network based educational system as claimed in claim 3, wherein the streaming video includes time specific commands that drive interactive elements of the system.

18. The network based educational system as claimed in claim 17, wherein the time specific commands drive flash slides.

19. The network based educational system as claimed in claim 17, wherein the time specific commands drive real-time questions and answers.

20. The network based educational system as claimed in claim 17, wherein the time specific commands are data script commands issued at specific time.

21. The network based educational system as claimed in claim 20, wherein the data script commands are embedded in the streaming video to JavaScript functions within the html and communicate with various media elements making up the system.

22. The network based educational system as claimed in claim 3, wherein the streaming video is provided with time stamps stored within a database of the system.

23. The network based educational system as claimed in claim 22, further comprising means for applying the time stamps to allow students to return to a specific stopping point in the event of an unplanned stoppage in receipt of class material.

24. The network based educational system as claimed in claim 23, wherein the means for applying includes a database of coursemarker tables recording a last question/slide seen by a student and a dynamically created video file sent to a student upon resumption of a discontinued class session.

25. The network based educational system as claimed in claim 1, wherein the administrative portal includes a question provider option allowing providers to monitor and control response time to test questions making up the classroom experience for students.

26. The network based education system as claimed in claim 25, wherein test questions are associated with a predetermined response time and predetermined ramifications are established for students failing to answer the test questions within the predetermined response time.

27. The network based educational system as claimed in claim 1, wherein the system is AICC and SCORM compliant.

28. The network based educational system as claimed in claim 1 further comprising means for identifying a student's connection speed and forwarding a student appropriate video format based upon the identified connection speed.

29. The network based education system as claimed in claim 1 further comprising a system test functionality.

30. The network based educational system as claimed in claim 29, wherein the system test functionality identifies operating system characteristics of a student chosen from the group consisting of an operating system, color depth, resolution and browser version, Internet Protocol address, host name, versions of software and bandwidth.

31. The network based education system as claimed in claim 29, wherein the system test is a Javascript function.

32. The network based education system as claimed in claim 1 wherein the network is the Internet.

33. The network based educational system as claimed in claim 1, wherein the classroom interface provides for real-time testing of students.

34. The network based educational system as claimed in claim 33, wherein the classroom interface is streaming video to bring instructional materials to students participating in the system.

35. The network based educational system as claimed in claim 33, wherein the streaming video includes time specific commands that drive the real-time testing of students.

36. The network based educational system as claimed in claim 35, wherein the time specific commands are data script commands issued at a specific time.

37. The network based educational system as claimed in claim 36, wherein the data script commands are embedded in the streaming video to JavaScript functions within the HTML and communicate with various media elements making up the system.

38. A network based educational interface, comprising:
a student interface;
a classroom interface; and
an administrative interface, wherein the student portal, the classroom interface and the administrative portal are each functionally linked to each other.

39. The network based interface as claimed in claim 38 wherein the student interface comprises a plurality of graphical elements functionally linked to a plurality of additional interfaces.

40. The network based interface as claimed in claim 38 wherein the classroom interface comprises a plurality of graphical elements functionally linked to a plurality of additional interfaces.

41. The network based interface as claimed in claim 40, wherein the classroom interface further comprises streaming video linked to one or more of the graphical elements.

42. The network based interface as claimed in claim 40, wherein the classroom interface further comprises asynchronous and synchronous applications linked to one or more of the graphical elements.

43. The network based interface as claimed in claim 38 further comprising a selfpublishing tool adapted to encode streaming video, index the streaming video and send the encoded video for use in the classroom interface.

44. A method of providing a network based education, comprising:
providing content on the network for a plurality of learners;
providing a platform from which the learners can receive the content;
delivering the content on the platform; and
supporting the content and the platform on the network.

45. The method as claimed in claim 44 wherein providing content comprises delivering streaming video.

46. The method as claimed in claim 45 wherein the video can include test questions to which one or more of the learners can provide answers.

47. The method as claimed in claim 46 wherein supporting the content comprises providing updated video content as needed.

48. The method as claimed in claim 47 wherein supporting the content further comprises providing real time measurement of the learners ability to retain the content.

49. A method of online education, comprising:
providing streaming video on a network;
sending questions and receiving answers through the streaming video;
optionally resuming the streaming video if the video was interrupted;
providing an auto-detect feature on the network to adjust the streaming video as needed; and
providing a systems test to optimize the streaming video delivery.
